(19) United States
(12) Patent Application Publication
(10) Pub. No.: US 2025/0102938 A1
(43) Pub. Date: Mar. 27, 2025

(54) TONER SET FOR ELECTROSTATIC IMAGE DEVELOPMENT, ELECTROSTATIC IMAGE DEVELOPER SET, TONER CARTRIDGE SET, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Koji FUNABA, Kanagawa (JP); Masahiro TAKAYAMA, Kanagawa (JP); Yuka ISHIHARA, Kanagawa (JP); Yukiko KAMIJO, Kanagawa (JP); Masashi IKEDA, Kanagawa (JP); Reina MURANO, Kanagawa (JP); Yuko HIRANO, Kanagawa (JP)

(73) Assignee: FUJIFILM Business Innovation Corp., Tokyo (JP)

(21) Appl. No.: 18/826,403

(22) Filed: Sep. 6, 2024

(30) Foreign Application Priority Data
Sep. 22, 2023 (JP) 2023-159172
Sep. 22, 2023 (JP) 2023-159204

(51) Int. Cl. G03G 9/08; G03G 9/087; G03G 9/09

(52) U.S. Cl. CPC G03G 9/0819; G03G 9/081; G03G 9/08755; G03G 9/0902

(57) ABSTRACT

A toner set for electrostatic image development includes a white toner including white toner particles containing a polyester resin and a white colorant, and a non-white color toner including color toner particles containing a vinyl resin, a polyester resin, and a color colorant, in which a mass ratio C of the polyester resin to the vinyl resin in the color toner particles is 0.7 or more and 10 or less.

### CROSS-REFERENCE TO RELATED APPLICATIONS

This application is based on and claims priority under 35 USC 119 from Japanese Patent Application No. 2023-159204 filed Sep. 22, 2023 and Japanese Patent Application No. 2023-159172 filed Sep. 22, 2023.

### BACKGROUND

### (i) Technical Field

The present disclosure relates to a toner set for electrostatic image development, an electrostatic image developer set, a toner cartridge set, a process cartridge, an image forming apparatus, and an image forming method.

### (ii) Related Art

As is known in the related art, a white toner is used in electrophotographic image formation for the purpose of forming a color image on a color recording medium or a transparent recording medium.

For example, Japanese Patent No. 7163574 proposes “an image forming method comprising forming an image by transferring a white toner and at least one color toner together to a recording medium and fixing the toners, wherein the color toner includes toner base particles, and the toner base particles have a plurality of protrusions disposed on at least a surface thereof”.

For example, Japanese Unexamined Patent Application Publication No. 2020-79868 proposes “an image forming method comprising forming an electrostatic latent image on an electrostatic latent image carrying member, developing the electrostatic latent image using a toner including toner base particles containing a binder resin, a luster pigment, a white pigment, and a release agent to form a white toner image, forming a color toner image with a color toner, transferring the toner image to a recording medium, and fixing a transferred image transferred to the recording medium, wherein the white toner image is formed closer to the recording medium than the color toner image is”.

Japanese Unexamined Patent Application Publication No. 2018-97016 proposes “a toner set comprising at least one selected from a white toner including white toner particles containing white colored particles, a color toner including color toner particles containing colored particles, and a transparent toner including transparent toner particles, wherein an average circularity of the white toner particles is smaller than an average circularity of either the color toner particles or the transparent toner particles, and a small-diameter-side number particle size distribution index of the white toner particles is larger than a small-diameter-side number particle size distribution index of either the color toner particles or the transparent toner particles”.

### SUMMARY

Aspects of non-limiting embodiments of the present disclosure relate to a toner set for electrostatic image development that provides an image including a color image on a white image with high color forming characteristics and suppresses color image peeling, compared with a toner set for electrostatic image development including a white toner including white toner particles containing a polyester resin and a white colorant, and a non-white color toner including color toner particles containing a vinyl resin, a polyester resin, and a color colorant, wherein a mass ratio C of the polyester resin to the vinyl resin in the color toner particles is less than 0.7 or more than 10.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner set for electrostatic image development, comprising:
a white toner including white toner particles containing a polyester resin and a white colorant; and
a non-white color toner including color toner particles containing a vinyl resin, a polyester resin, and a color colorant,
wherein a mass ratio C of the polyester resin to the vinyl resin in the color toner particles is 0.7 or more and 10 or less.

### BRIEF DESCRIPTION OF THE DRAWINGS

Exemplary embodiments of the present disclosure will be described in detail based on the following figures, wherein:

FIG. 1 illustrates a schematic configuration of an example of an image forming apparatus according to an exemplary embodiment;

FIG. 2 illustrates a schematic configuration of an example of a process cartridge according to an exemplary embodiment; and

FIG. 3 illustrates a schematic configuration of an example of a screw extruder used in kneading pulverization.

### DETAILED DESCRIPTION

Exemplary embodiments of the present disclosure will be described below. The description and examples below are illustrative of the exemplary embodiments and are not intended to limit the scope of the disclosure.

In the exemplary embodiments, a numerical range expressed using “to” indicates a range including the numerical values before and after “to” as the minimum value and the maximum value.

In numerical ranges described in stages in the exemplary embodiments, the upper limit or the lower limit described in one numerical range may be replaced with the upper limit or the lower limit of other numerical ranges described in stages. In a numerical range described in the exemplary embodiments, the upper limit or the lower limit of the numerical range may be replaced with a value described in Examples.

The term “step” in the exemplary embodiments encompasses not only a separate step but also a step that is not clearly distinguished from another step if the desired object of the step is achieved.

In the exemplary embodiments, when an exemplary embodiment is described with reference to the drawings, the configuration of the exemplary embodiment is not limited to the configuration illustrated in the drawings. In addition, the size of members in figures is conceptual, and the relative size relationship between the members is not limited thereto.

In the exemplary embodiments, components may each include a plurality of corresponding substances. In the exemplary embodiments, if there are two or more substances corresponding to one component in a composition, the amount of the component in the composition refers to the total amount of the two or more substances present in the composition unless otherwise specified.

In the exemplary embodiments, the notation “(meth)acrylic” is meant to include both “acrylic” and “methacrylic”.

In the exemplary embodiments, a “white toner for electrostatic image development” is also referred to simply as a “white toner”, a “color toner for electrostatic image development” is also referred to simply as a “color toner”, an “electrostatic image white developer” is also referred to simply as a “white developer”, and an “electrostatic image color developer” is also referred to simply as a “color developer”. In the exemplary embodiments, a “toner set for electrostatic image development” is also referred to simply as a “toner set”, and an “electrostatic image developer set” is also referred to simply as a “developer set”.

Toner Set for Electrostatic Image Development A toner set according to an exemplary embodiment includes a white toner including white toner particles containing a polyester resin and a white colorant, and a non-white color toner including color toner particles containing a vinyl resin, a polyester resin, and a color colorant.

The mass ratio C of the polyester resin to the vinyl resin in the color toner particles is 0.7 or more and 10 or less.

With this configuration, the toner set according to the exemplary embodiment provides an image including a color image on a white image with high color forming characteristics and suppresses color image peeling. The reason for this is presumably as follows.

For image formation on a recording medium, e.g., color paper such as black paper or a film such as a beverage label, in order to provide a color image with higher color forming characteristics, the color image may be formed on a white image as a base.

There is known a combination in which a binder resin of white toner particles includes a polyester resin and a binder resin of color toner particles includes a vinyl resin (e.g., a styrene-acrylic resin) and a polyester resin. This is probably because the use of the polyester resin in the white toner allows a white pigment to be easily dispersed, and the combined use of the vinyl resin, which is less likely to experience a decrease in charging at high temperature and high humidity, and the polyester resin, which has high fixability, in the color toner provides a good balance.

On the other hand, to prevent the color image from peeling off upon rubbing or the like, the white image and the color image may be fixed together with high adhesion.

However, in the case of the combination in which a binder resin of white toner particles includes a polyester resin and a binder resin of color toner particles includes a vinyl resin (e.g., a styrene-acrylic resin) and a polyester resin, components of the white toner particles and the color toner particles are poorly compatible with each other at the time of fixing, resulting in low adhesion of a color image to a white image. Thus, color image peeling occurs when the image is rubbed.

On the other hand, if the components of the white toner particles and the color toner particles are too compatible with each other at the time of fixing, the components of the white toner particles and the color toner particles excessively mix with each other to cause color mixing, resulting in a color image with low color forming characteristics.

In particular, if the components of the white toner particles and the color toner particles are excessively compatible with each other at the time of fixing, the white colorant for a white image is poorly dispersed, resulting in non-uniform light scattering and hence a color image with low color forming characteristics. In particular, when an image is formed on a recording medium with large surface irregularities, such as embossed paper, a white image with an uneven thickness is formed, and thus if the white colorant is poorly dispersed, the color forming characteristics of a color image tends to be low.

Thus, in the toner set according to the exemplary embodiment, the mass ratio C of the polyester resin to the vinyl resin in the color toner particles is 0.7 or more and 10 or less.

In the color toner particles containing a vinyl resin and a polyester resin as binder resins at the above mass ratio C, the vinyl resin, which has low fixability, and the polyester resin, which causes mixing with the components of the white toner, are moderately contained.

Thus, at the time of fixing, the affinity between the white toner particles and the color toner particles is moderate, and the components of these toner particles are moderately compatible with each other, sufficiently securing the adhesion between a white image and a color image. In addition, the components of these toner particles are less likely to be excessively compatible with each other, suppressing excessive mixing of the components as well as poor dispersion of the white colorant for a white image. As a result, color mixing of the white colorant and the color colorant is suppressed, while scattering properties of a white image are exhibited, suppressing a decrease in color forming characteristics of a color image.

From the above, it is presumed that the toner set according to the exemplary embodiment achieves both suppression of peeling of an image including a color image on a white image and improvement in color forming characteristics of the color image.

Hereinafter, details of the toner set according to the exemplary embodiment will be described.

### Resin Amount of White Toner and Color Toner

### Mass Ratio C

The mass ratio C of the polyester resin to the vinyl resin in the color toner particles is 0.7 or more and 10 or less.

When the mass ratio C is less than 0.7, the vinyl resin ratio in the color toner particles is too high, and the white toner particles and the color toner particles are not easily compatible with each other at the time of fixing, resulting in low adhesion between a white image and a color image. Thus, color image peeling worsens.

When the mass ratio C is more than 10, the polyester resin ratio in the color toner particles is too high, which results in excessive mixing with the polyester resin of the white toner particles at the time of fixing to cause color mixing of the white colorant and the color colorant and poor dispersion of the white pigment, resulting in a color image with low color forming characteristics.

From the viewpoint of suppression of color image peeling and improvement in color forming characteristics of a color image, the mass ratio C is preferably 2 or more and 6 or less, more preferably 3 or more and 5 or less.

### Relationship Between Mass Ratio C and Mass Ratio W

When the white toner particles contain a vinyl resin, the relationship between the mass ratio W of the polyester resin to the vinyl resin in the white toner particles and the mass ratio C of the polyester resin to the vinyl resin in the color toner particles preferably satisfies −0.6≤W−C≤5.6.

The relationship between the mass ratio W and the mass ratio C, W−C, more preferably satisfies 0≤W−C≤4, still more preferably satisfies 1≤W−C≤3.

When the relationship between the mass ratio W and the mass ratio C, W−C, is in the above range, the relationship of the vinyl resin-to-polyester resin ratio between the white toner particles and the color toner particles is appropriate, and the polyester resins of the white toner particles and the color toner particles moderately mix together at the time of fixing, so that the adhesion between a white image and a color image sufficiently improves, and a decrease in color forming characteristics of the color image is suppressed, while color image peeling is easily suppressed.

### Measurement of Content of Each Resin in Toner Particles

The content of each resin in the toner particles (the white toner particles and the color toner particles) is measured as described below.

First, each resin contained in the toner particles can be identified by known nuclear magnetic resonance measurement, infrared spectrometry, and pyrolysis gas chromatography-mass spectrometry.

The content of each resin in the toner particles can be determined by centrifugation and measurement of ¹H-NMR spectra using a nuclear magnetic resonance apparatus. The details are as follows.

The toner particles (or toner) whose mass has been measured in advance are dissolved in toluene and then centrifuged to separate a resin component and a non-resin component from each other.

Next, a solution in which the resin component is dissolved is recovered, and a solvent is removed by drying to obtain the resin component (i.e., solid matter). From the mass of the resin component, the mass ratio between the resin component and the non-resin component solid matter is determined.

Next, 10 mg of the resin component is dissolved in 0.7 mL of a deuterated chloroform solution, and tetramethylsilane (TMS) as a reference material is added at a concentration of 0.05 vol %; the resulting solution is used as a measurement sample.

Next, the measurement sample is subjected to a ¹H-NMR spectrum measurement using a nuclear magnetic resonance apparatus (JNM-AL400 (manufactured by JEOL Ltd.)). The measurement conditions are as follows: reference material, tetramethylsilane (TMS); temperature, 25° C.; the number of acquisitions, 128.

Next, the ¹H-NMR spectrum obtained is analyzed to determine a chemical shift and an integral ratio, and from the chemical shift and the integral ratio, the molar ratio of monomers constituting the resins is determined.

Finally, the molar ratio of the monomers is multiplied by the molecular weight of a polymerization segment unit to convert the molar ratio into a mass ratio. Thus, the content of each resin in the toner particles is determined.

### Variance P Parameter

In a cross section of the white toner particles, the variance P parameter determined by measuring the white colorant by the block method is preferably 0.85 or more and 1.00 or less, more preferably 0.90 or more and 1.00 or less, still more preferably 0.92 or more and 1.00 or less.

When the variance P parameter is in the above range, the dispersibility of the white colorant in a white image after fixing is increased, and the light scattering properties of the white image are fully exerted, which helps improve the color forming characteristics of a color image.

The variance P parameter may be adjusted by, for example,
(1) performing two-stage kneading of a first kneading step and a second kneading step, or
(2) controlling the rotation speed of a screw
   in kneading pulverization described later.

In (1), the kneading may be performed, for example, in such a manner that each resin in an amount of ⅕ to ⅓ and the whole amount of the white pigment are kneaded in the first kneading step and all the rest of each resin are kneaded in the second kneading step.

### Cross-Sectional Properties of White Toner Particles

When a cross section of the white toner particles is observed, the white colorant has an area fraction of 10% or more and 50% or less, and the white colorant has a number-average particle size of 0.23 μm or more and 0.45 μm or less.

With this configuration, the toner set according to the exemplary embodiment provides an image including a color image on a white image with high color forming characteristics and suppresses image peeling upon bending.

The polyester resin melts at a lower viscosity than the vinyl resin, and when the white colorant in an appropriate amount and size in the above ranges is contained together with the polyester resin in the white toner particles, the filler effect of the white colorant gives the white toner particles a melt viscosity at which the white toner particles are easily compatible with a small amount of the polyester resin in the color toner particles at a fixing temperature. Accordingly, the white toner particles and the color toner particles are compatible with each other at the time of fixing but are prevented from being excessively compatible with each other. Thus, the white image and the color image come into so close contact with each other due to the resins being compatible with each other at the interface, while the components are not excessively mixed with each other, so that the images are not easily broken upon bending. As a result, the color forming characteristics of the color image are maintained, and image peeling upon bending is suppressed.

When the white colorant has an area fraction of more than 50% or a number-average particle size of more than 0.45 μm, the filler effect is not easily produced, and the components of the white toner particles and the color toner particles are excessively compatible or mixed with each other at the time of fixing, resulting in a color image with low color forming characteristics.

When the white colorant has an area fraction of less than 10% or a number-average particle size of less than 0.23 μm, the filler effect is excessively produced, and the components of the white toner particles and the color toner particles are not easily compatible with each other at the time of fixing, increasing the likelihood of image peeling upon bending.

From the viewpoint of suppression of image peeling and improvement in color forming characteristics of a color image, the area fraction of the white colorant is preferably 20% or more and 50% or less, more preferably 30% or more and 40% or less.

From the same viewpoint, the number-average particle size of the white colorant is preferably 0.23 μm or more and 0.30 μm or less, more preferably 0.26 μm or more and 0.30 μm or less.

The area fraction and number-average particle size of the white colorant may be adjusted by, for example, using, in kneading pulverization described later, a colorant prepared by premixing two or more white colorants having different particle sizes, with the particle sizes and mixing ratio of the two or more white colorants having different particle sizes being adjusted.

### Particle Size Distribution of White Colorant

When a cross section of the white toner particles is observed, the proportion of a white colorant with a particle size of 100 nm or less relative to the entire white colorant is preferably 30 number % or less, more preferably 20 number %, still more preferably 18 number %.

When the proportion of a white colorant with a particle size of 100 nm or less is in the above range, the filler effect of the white colorant gives the white toner a viscosity at which the white toner is easily compatible with a small amount of the polyester resin in the color toner at a fixing temperature. Thus, image peeling upon bending is suppressed, and the color forming characteristics of an image tends to improve.

The variance P parameter and the area fraction, the number-average particle size, and the proportion of a white colorant with a particle size of 100 nm or less of the white colorant are determined as follows.

The white toner is mixed and embedded in an epoxy resin, and the epoxy resin is cured. The resulting cured product is sliced with an ultramicrotome (Ultracut UCT manufactured by Leica Microsystems) to prepare a thin sample having a thickness of 250 nm.

Next, a white toner particle section of the thin sample is observed at a magnification of 10000× under a scanning electron microscope STEM (S-4800 manufactured by Hitachi High-Tech Corporation) to obtain an STEM image.

Next, the STEM image is analyzed with an image processing analysis system (LUZEX AP manufactured by NIRECO CORPORATION), and the white colorant in the white toner particles is identified by binarization. In the binarization, the outline of the white colorant is extracted on the basis of the color and shape.

Next, a dividing line is drawn such that the length of the line dividing the white toner particle section into two is longest, and an analysis region 2 μm long and 2 μm wide is defined such that the center position of the dividing line is the center of the analysis region.

Next, the analysis region is split into four equal blocks, each block being 1 μm long and 1 μm wide.

Next, from the area of the white colorant in each block, a variance P parameter is calculated by equations (P1) and (P2) below.

This procedure is performed on 100 white toner particles to calculate variance P parameters, and their arithmetic average is determined.

Regarding the variance P parameter, values closer to 1 indicate that the areas of the blocks are more uniform and the dispersibility of the white colorant is higher, and values closer to 0 indicate that the areas of the blocks are more varied and the dispersibility of the white colorant is lower.

Next, the areas of the white toner particle section and the white colorant on the image are determined, and the area fraction of the white colorant relative to the white toner particle section is determined.

This procedure is performed on 10 white toner particles, and the arithmetic average of area fractions of the white colorant is determined.

Meanwhile, the equivalent circle diameter of the white colorant on the image is determined. Specifically, the area of each particle is measured, and the equivalent circle diameter is calculated from the area value. This procedure is performed on 10 white toner particles, and the number-based particle size distribution of the white colorant is determined.

In the particle size distribution obtained, the cumulative 50% particle size on a number basis is determined as the number-average particle size.

In the particle size distribution obtained, the proportion (number %) of a white colorant with a particle size of 100 nm or less relative to the entire white colorant is also determined.

$$P = \frac{\text{?} ln \text{?}}{ln ( 1 / n )} \qquad ( P1 )$$

$$\text{?} = \frac{\text{?}}{\text{?}} \qquad ( P2 )$$

$$\text{?} \text{indicates text missing or illegible when filed}$$

In the equations (P1) and (P2), n represents the number of blocks (=4), and bi represents the area (m²) of the white colorant in a block i.

### Configuration of White Toner and Color Toner

Hereinafter, constituents of the toners (the white toner and the color toner) included in the toner set according to the exemplary embodiment will be described.

The toners in the exemplary embodiment each include toner particles and may further include an external additive.

As used herein, the terms “color toner”, “color toner particles”, “color colorant”, and “color image” respectively refer to a toner, toner particles, a colorant, and an image that have a color other than white. Examples of the color toner include color toners, such as yellow (Y), magenta (M), and cyan (C) toners, and a black (K) toner.

The color toner may be a combination of toners of a plurality of colors; for example, toners of four colors, a yellow toner, a magenta toner, a cyan toner, and a black toner, may be used in combination to constitute the toner set together with the white toner. In this case, at least one toner of the color toners may satisfy the above-described conditions, and all the color toners used in combination may satisfy the above-described conditions.

### Toner Particles

The white toner particles contain a polyester resin as a binder resin and a white colorant. The white toner particles may contain a polyester resin and a vinyl resin as binder resins.

The color toner particles contain a vinyl resin and a polyester resin as binder resins and a color colorant.

The toner particles (the white toner particles and the color toner particles) may contain a release agent and other additives.

Hereinafter, each component will be described.

### Binder Resin

The polyester resin will be described.

Examples of the polyester resin include known amorphous polyester resins. The polyester resin may be a combination of an amorphous polyester resin with a crystalline polyester resin. The crystalline polyester resin may be used in an amount of 2 mass % or more and 40 mass % or less (preferably 2 mass % or more and 20 mass % or less) relative to the total mass of the binder resin.

“Crystalline” in the context of a resin means that the resin shows a distinct endothermic peak, rather than a stepwise endothermic change, in differential scanning calorimetry (DSC), and specifically means that the half-width of the endothermic peak measured at a temperature increase rate of 10° C./min is within 10° C.

“Amorphous” in the context of a resin means that the half-width exceeds 10° C., that a stepwise endothermic change is shown, or that no distinct endothermic peak is observed.

Amorphous Polyester Resin Examples of the amorphous polyester resin include polycondensates of polycarboxylic acids with polyhydric alcohols. The amorphous polyester resin for use may be a commercially available product or may be synthesized.

Examples of the polycarboxylic acids include aliphatic dicarboxylic acids (e.g., oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, and lower (e.g., C1 to C5) alkyl esters thereof. Of these, aromatic dicarboxylic acids are preferred, for example.

The polycarboxylic acid may be a combination of a dicarboxylic acid with a trivalent or higher valent carboxylic acid having a crosslinked or branched structure. Examples of the trivalent or higher valent carboxylic acid include trimellitic acid, pyromellitic acid, anhydrides thereof, and lower (e.g., C1 to C5) alkyl esters thereof.

These polycarboxylic acids may be used alone or in combination of two or more.

Examples of the polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these, aromatic diols and alicyclic diols are preferred, for example, and aromatic diols are more preferred. The polyhydric alcohol may be a combination of a diol with a trivalent or higher valent polyhydric alcohol having a crosslinked or branched structure. Examples of the trivalent or higher valent polyhydric alcohol include glycerol, trimethylolpropane, and pentaerythritol.

These polyhydric alcohols may be used alone or in combination of two or more.

The glass transition temperature (Tg) of the amorphous polyester resin is preferably 50° C. or higher and 80° C. or lower, more preferably 50° C. or higher and 65° C. or lower.

The glass transition temperature is determined from a DSC curve obtained by differential scanning calorimetry (DSC), and is more specifically determined in accordance with “Extrapolation Glass Transition Onset Temperature” described in Determination of Glass Transition Temperature in JIS K 7121-1987 “Testing Methods for Transition Temperatures of Plastics”.

The weight-average molecular weight (Mw) of the amorphous polyester resin is preferably 5,000 or more and 1,000,000 or less, more preferably 7,000 or more and 500,000 or less.

The number-average molecular weight (Mn) of the amorphous polyester resin is preferably 2,000 or more and 100,000 or less.

The molecular weight distribution Mw/Mn of the amorphous polyester resin is preferably 1.5 or more and 100 or less, more preferably 2 or more and 60 or less.

The weight-average molecular weight and the number-average molecular weight are determined by gel permeation chromatography (GPC). The molecular weight determination by GPC is performed using an HLC-8120GPC system manufactured by Tosoh Corporation as a measurement apparatus, a TSKgel SuperHM-M column (15 cm) manufactured by Tosoh Corporation, and a THF solvent. The weight-average molecular weight and the number-average molecular weight are calculated using a molecular weight calibration curve prepared from the measurement results relative to monodisperse polystyrene standards.

The amorphous polyester resin is obtained by a well-known production method. Specifically, the amorphous resin is obtained by, for example, performing a reaction at a polymerization temperature of 180° C. or higher and 230° C. or lower, optionally while removing water and alcohol produced during condensation by reducing the pressure in the reaction system.

If any starting monomer is insoluble or incompatible at the reaction temperature, it may be dissolved by adding a high-boiling solvent as a solubilizer. In this case, the polycondensation reaction is performed while the solubilizer is distilled off. If a poorly compatible monomer is present, the poorly compatible monomer may be condensed in advance with an acid or alcohol to be polycondensed with the monomer before being polycondensed together with the major components.

### Crystalline Polyester Resin

Examples of the crystalline polyester resin include polycondensates of polycarboxylic acids with polyhydric alcohols. The crystalline polyester resin for use may be a commercially available product or may be synthesized.

To easily form a crystalline structure, the crystalline polyester resin may be a polycondensate obtained using linear aliphatic polymerizable monomers rather than aromatic polymerizable monomers.

Examples of the polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids such as phthalic acid, isophthalic acid, terephthalic acid, and naphthalene-2,6-dicarboxylic acid), anhydrides thereof, and lower (e.g., C1 to C5) alkyl esters thereof.

The polycarboxylic acid may be a combination of a dicarboxylic acid with a trivalent or higher valent carboxylic acid having a crosslinked or branched structure. Examples of the tricarboxylic acid include aromatic carboxylic acids (e.g., 1,2,3-benzenetricarboxylic acid, 1,2,4-benzenetricarboxylic acid, and 1,2,4-naphthalenetricarboxylic acid), anhydrides thereof, and lower (e.g., C1 to C5) alkyl esters thereof.

The polycarboxylic acid may be a combination of such a dicarboxylic acid with a dicarboxylic acid having a sulfonic group or a dicarboxylic acid having an ethylenic double bond.

These polycarboxylic acids may be used alone or in combination of two or more.

Examples of the polyhydric alcohols include aliphatic diols (e.g., linear aliphatic diols having 7 to 20 main-chain carbon atoms). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these, 1,8-octanediol, 1,9-nonanediol, and 1,10-decanediol are preferred.

The polyhydric alcohol may be a combination of a diol with a trivalent or higher valent alcohol having a crosslinked or branched structure. Examples of the trivalent or higher valent alcohol include glycerol, trimethylolethane, trimethylolpropane, and pentaerythritol.

These polyhydric alcohols may be used alone or in combination of two or more.

The amount of aliphatic diol contained in the polyhydric alcohol may be 80 mol % or more, and is preferably 90 mol % or more.

The melting temperature of the crystalline polyester resin is preferably 50° C. or higher and 100° C. or lower, more preferably 55° C. or higher and 90° C. or lower, still more preferably 60° C. or higher and 85° C. or lower.

The melting temperature is determined from a DSC curve obtained by differential scanning calorimetry (DSC) in accordance with “Melting Peak Temperature” described in Determination of Melting Temperature of JIS K 7121-1987 “Testing Methods for Transition Temperatures of Plastics”.

The weight-average molecular weight (Mw) of the crystalline polyester resin may be 6,000 or more and 35,000 or less.

The crystalline polyester resin is produced by, for example, a well-known method, as with the amorphous polyester.

The vinyl resin will be described.

Examples of the vinyl resin include vinyl resins formed of homopolymers of monomers such as styrenes (e.g., styrene, p-chlorostyrene, and α-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene); and vinyl resins formed of copolymers of two or more of these monomers.

These vinyl resins may be used alone or in combination of two or more.

The vinyl resin may be a styrene-acrylic resin from the viewpoint of being excellent in environmental stability of toner charging, charge controllability, color forming characteristics of a color image, and image peeling suppression.

The styrene-acrylic resin is a copolymer obtained by copolymerization of at least a styrene monomer (a monomer having a styrene backbone) and a (meth)acrylic monomer (a monomer having a (meth)acryloyl group, preferably a monomer having a (meth)acryloyloxy group). The styrene-acrylic resin, for example, includes a copolymer of a styrene monomer and any of the above (meth)acrylate monomers. The acrylic resin moiety in the styrene-acrylic resin is either an acrylic monomer or a methacrylic monomer, or a partial structure formed through polymerization thereof. The expression “(meth)acrylic” is meant to include both “acrylic” and “methacrylic”.

Specific examples of the styrene monomer include styrene, alkyl-substituted styrenes (e.g., α-methylstyrene, 2-methylstyrene, 3-methylstyrene, 4-methylstyrene, 2-ethylstyrene, 3-ethylstyrene, and 4-ethylstyrene), halogen-substituted styrenes (e.g., 2-chlorostyrene, 3-chlorostyrene, and 4-chlorostyrene), and vinylnaphthalene. These styrene monomers may be used alone or in combination of two or more.

Of these styrene monomers, styrene is preferred for its ease of reaction, ease of reaction control, and availability.

Specific examples of the (meth)acrylic monomer include (meth)acrylic acid and (meth)acrylates. Examples of the (meth)acrylates include alkyl (meth)acrylates (e.g., methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), aryl (meth)acrylates (e.g., phenyl (meth)acrylate, biphenyl (meth)acrylate, diphenylethyl (meth)acrylate, t-butylphenyl (meth)acrylate, and terphenyl (meth)acrylate), dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, and (meth)acrylamides. These (meth)acrylate monomers may be used alone or in combination of two or more.

Of these (meth)acrylates among the (meth)acrylic monomers, (meth)acrylates having an alkyl group having 2 to 14 (preferably 2 to 10, more preferably 3 to 8) carbon atoms are preferred from the viewpoint of increasing the fixability of the toners. In particular, n-butyl (meth)acrylate is preferred, and n-butyl acrylate is particularly preferred.

The copolymerization ratio (by mass) of the styrene monomer to the (meth)acrylic monomer (styrene monomer/(meth)acrylic monomer) is not particularly limited, and may be 98/2 to 60/40.

The styrene-acrylic resin may have a crosslinked structure. The styrene-acrylic resin having a crosslinked structure may be, for example, a copolymer of at least a styrene monomer, a (meth)acrylate monomer, and a crosslinkable monomer.

Examples of the crosslinkable monomer include bi- or higher functional crosslinking agents.

Examples of bifunctional crosslinking agents include divinylbenzene, divinylnaphthalene, di(meth)acrylate compounds (e.g., diethylene glycol di(meth)acrylate, methylenebis(meth)acrylamide, decanediol diacrylate, and glycidyl (meth)acrylate), polyester di(meth)acrylates, and 2-([1′-methylpropylideneamino]carboxyamino)ethyl (meth)acrylate.

Examples of tri- or higher functional crosslinking agents include tri(meth)acrylate compounds (e.g., pentaerythritol tri(meth)acrylate, trimethylolethane tri(meth)acrylate, and trimethylolpropane tri(meth)acrylate), tetra(meth)acrylate compounds (e.g., pentaerythritol tetra(meth)acrylate and oligoester (meth)acrylates), 2,2-bis(4-methacryloxypolyethoxyphenyl)propane, diallyl phthalate, triallyl cyanurate, triallyl isocyanurate, triallyl trimellitate, and diallyl chlorendate.

Among them, from the viewpoint of increasing the fixability of the toners, the crosslinkable monomer is preferably a bi- or higher functional (meth)acrylate compound, more preferably a bifunctional (meth)acrylate compound, still more preferably a bifunctional (meth)acrylate compound having an alkylene group having 6 to 20 carbon atoms, particularly preferably a bifunctional (meth)acrylate compound having a linear alkylene group having 6 to 20 carbon atoms.

The copolymerization ratio (by mass) of the crosslinkable monomer to all monomers (crosslinkable monomer/all monomers) is not particularly limited, and may be 2/1,000 to 20/1,000.

From the viewpoint of increasing the fixability of the toners, the glass transition temperature (Tg) of the styrene-acrylic resin is preferably 40° C. or higher and 75° C. or lower, more preferably 50° C. or higher and 65° C. or lower.

The glass transition temperature of the resin is determined from a DSC curve obtained by differential scanning calorimetry (DSC). More specifically, the glass transition temperature of the resin is determined in accordance with “Extrapolation Glass Transition Onset Temperature” described in Determination of Glass Transition Temperature in JIS K 7121: 1987 “Testing Methods for Transition Temperatures of Plastics”.

From the viewpoint of storage stability of the toners, the weight-average molecular weight of the styrene-acrylic resin is preferably 5,000 or more and 200,000 or less, more preferably 10,000 or more and 100,000 or less, particularly preferably 20,000 or more and 80,000 or less.

The weight-average molecular weight and the number-average molecular weight of the resin are determined by gel permeation chromatography (GPC). The molecular weight determination by GPC is performed using an HLC-8120GPC system manufactured by Tosoh Corporation as a measurement apparatus, a TSKgel SuperHM-M column (15 cm) manufactured by Tosoh Corporation, and a THF solvent. The weight-average molecular weight and the number-average molecular weight are calculated using a molecular weight calibration curve prepared from the measurement results relative to monodisperse polystyrene standards.

The styrene-acrylic resin may be produced by any method, and various polymerization methods (e.g., solution polymerization, precipitation polymerization, suspension polymerization, bulk polymerization, and emulsion polymerization) may be used. The polymerization reaction is carried out by using a known process (e.g., a batch process, a semi-continuous process, or a continuous process).

Here, the styrene-acrylic resin and the polyester resin can coexist in the form of not only a mixture of these resins but also a chemically bonded hybrid resin (so-called styrene-acrylic-modified polyester resin) having a styrene-acrylic resin segment and a polyester resin segment. Specifically, the hybrid resin can be obtained by polymerizing a polyester monomer having an unsaturated structure such as fumaric acid or succinic acid or a prepolymer formed of a resin including such a monomer structure with a vinyl monomer such as styrene or acryl.

When the hybrid resin (so-called styrene-acrylic-modified polyester resin) is used, the mass ratios C and W of the polyester resin to the vinyl resin are measured and calculated as mass ratios of a polyester segment to a vinyl resin segment (e.g., a styrene-acrylic resin segment) of the hybrid resin. When the hybrid resin, the vinyl resin (e.g., the styrene-acrylic resin), and the polyester resin are used in combination, the mass ratios C and W are measured and calculated as mass ratios of the sum of the polyester resin segment of the hybrid resin and the polyester resin to the sum of the vinyl resin segment of the hybrid resin and the vinyl resin.

### Colorant

As a colorant, a white colorant is used in the case of white toner particles, and a color colorant other than the white colorant is used in the case of color toner particles.

In the case of the white toner particles, as long as the white colorant is contained in an amount of 15 mass % or more relative to the mass of the toner particles, the toner is regarded as a white toner even if the color colorant is contained.

### White Colorant

Examples of the white colorant include inorganic pigments and organic pigments.

Specific examples of the white colorant include inorganic pigments such as ground calcium carbonate, precipitated calcium carbonate, titanium dioxide, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, and smectite; and organic pigments such as polystyrene resin particles and urea formalin resin particles.

Of these, from the viewpoint of having higher opacity and forming white images that provide color images with even better color tones, the white colorant may be at least one selected from the group consisting of titanium oxide, silicon dioxide, aluminum oxide, zinc oxide, and zirconium oxide.

In particular, the white colorant may be titanium oxide from the viewpoint of high opacity. The titanium oxide may have an anatase-type, rutile-type, or brookite-type crystal structure.

The white colorant may be surface treated as needed or may be used in combination with a dispersant.

From the viewpoint of high opacity, the number-average particle size of the white colorant measured for the white colorant alone (hereinafter also referred to as “the number-average particle size Dcc of the white colorant alone”) is preferably 150 nm or more and 900 nm or less, more preferably 180 nm or more and 800 nm or less, still more preferably 200 nm or more and 700 nm or less.

The number-average particle size Dcc of the white colorant alone is calculated as follows: 100 mg of the white colorant is added to 10 ml of a 1:1 water-ethanol mixture, and the resulting mixture is dispersed with an ultrasonic cleaner, after which one drop of the dispersion is dropped on a mesh for STEM observation and immediately blown off with a blower to dryness, and an image of the resultant is captured by STEM observation under a scanning electron microscope SEM (S-4800 manufactured by Hitachi High-Tech Corporation), which image is imported into an image analyzer (LUZEX AP manufactured by NIRECO CORPORATION) and subjected to image analysis. Specifically, the area of each particle is measured, and the equivalent circle diameter is calculated from the area value.

Specifically, an image is captured with an electron microscope such that about 10 to 50 pieces of the white colorant is shown in one field of view, the area of each particle is determined by image analysis, and the equivalent circle diameter is calculated from the area value. The average of equivalent circle diameters of 100 pieces in a plurality of fields of view is determined as the number-average particle size Dcc of the white colorant alone.

The above white colorants may be used alone or in combination of two or more.

The content of the white colorant is preferably 15 mass % or more and 65 mass % or less, more preferably 20 mass % or more and 60 mass % or less, still more preferably 30 mass % or more and 50 mass % or less relative to the total mass of the white toner particles.

When the content of the white colorant is in the above range, color image peeling is suppressed, while the light scattering properties of a white image are increased, and in addition, image peeling is suppressed, while the reflectance of the white image is increased, which helps improve the color forming characteristics of a color image.

Color Colorant Examples of the color colorant include various pigments such as carbon black, chromium yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These color colorants may be used alone or in combination of two or more.

The content of the color colorant is, for example, preferably 1 mass % or more and 30 mass % or less, more preferably 2 mass % or more and 15 mass % or less relative to the total mass of the color toner particles.

Release Agent Examples of the release agent include hydrocarbon waxes; natural waxes such as carnauba wax, rice wax, and Candelilla wax; synthetic or mineral/petroleum waxes such as montan wax; and ester waxes such as fatty acid esters and montanic acid esters. The release agent is not limited thereto. The release agent for the color toner particles may be an ester wax.

Other Additives Examples of other additives include known additives such as magnetic materials, charge control agents, and inorganic powders. These additives are contained as internal additives in the toner particles.

### Properties of Toner Particles

The toner particles may be toner particles having a single-layer structure or toner particles having what is called a core-shell structure composed of a core (core particle) and a coating layer (shell layer) covering the core.

The toner particles having a core-shell structure may be composed of, for example, a core and a coating layer, the core containing a binder resin and other optional additives such as a colorant and a release agent, the coating layer containing a binder resin.

For the volume-average particle size of the toner particles, the white toner particles and the color toner particles each have their own suitable range. The details are as follows.

The volume-average particle size DW of the white toner particles is preferably 5.0 μm or more and 10.0 μm or less, more preferably 6.0 μm or more and 9.0 μm or less.

The volume-average particle size DW of the color toner particles is preferably 3.0 μm or more and 8.0 μm or less, more preferably 4.0 μm or more and 7.0 μm or less.

The volume-average particle size of the toner particles is measured using a COULTER MULTISIZER II (manufactured by Beckman Coulter, Inc.) and an ISOTON-II electrolyte solution (manufactured by Beckman Coulter, Inc.).

In the measurement, 0.5 mg or more and 50 mg or less of a test sample is added into 2 ml of a 5% aqueous solution of a surfactant (e.g., sodium alkylbenzenesulfonate) serving as a dispersant. The resulting solution is added into 100 ml or more and 150 ml or less of the electrolyte solution.

The electrolyte solution in which the sample is suspended is dispersed with an ultrasonic disperser for 1 minute, and the particle size distribution of particles having a particle size of 2 μm or more and 60 μm or less is measured with the COULTER MULTISIZER II using an aperture with an aperture size of 100 μm. The number of sampled particles is 50,000.

The measured particle size distribution is divided into particle size ranges (channels), and cumulative volume and number distributions are plotted against the particle size ranges from smaller to larger sizes; the volume particle size D16v and the number particle size D16p are defined as the particle size at which the cumulative volume or number is 16%, and the volume-average particle size D50v is defined as the particle size at which the cumulative volume is 50%.

The average circularity of the toner particles is preferably 0.90 or more and 1.00 or less, more preferably 0.92 or more and 0.98 or less.

The average circularity of the toner particles is determined by (peripheral length of equivalent circle)/(peripheral length) [(peripheral length of circle having same projected area as that of particle image)/(peripheral length of projected particle image)]. Specifically, the average circularity is measured in the following manner.

First, target toner particles are collected by suction to form a flat flow, and strobe light is flashed to capture a still particle image, which particle image is analyzed with a flow particle image analyzer (FPIA-3000 manufactured by Sysmex Corporation). The number of particles sampled for determining the average circularity is 3,500.

When the toner contains an external additive, the toner (developer) to be measured is dispersed in water containing a surfactant and then sonicated to obtain toner particles from which the external additive has been removed.

External Additive Examples of the external additive include inorganic particles. Examples of the inorganic particles include SiO₂, TiO₂, SrTiO₃, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃₋₂SiO₂, CaCO₃, MgCO₃, BaSO₄, and MgSO₄.

From the viewpoint of suppressing color image peeling while increasing the light scattering properties of a white image and helping improve the color forming characteristics of a color image, the external additive may be SiO₂.

The surface of inorganic particles used as an external additive may be subjected to hydrophobic treatment. The hydrophobic treatment may be performed by, for example, immersing the inorganic particles in a hydrophobizing agent. Non-limiting examples of the hydrophobizing agent include silane coupling agents, silicone oil, titanate coupling agents, and aluminum coupling agents. These hydrophobizing agents may be used alone or in combination of two or more.

The amount of hydrophobizing agent is typically, for example, 1 part by mass or more and 10 parts by mass or less relative to 100 parts by mass of the inorganic particles.

Other examples of the external additive include resin particles (particles of resins such as polystyrene, polymethyl methacrylate (PMMA), and melamine resins) and cleaning active agents (e.g., particles of higher fatty acid metal salts typified by zinc stearate and fluoropolymers).

The amount of external additive added is, for example, preferably 0.01 mass % or more and 10 mass % or less, more preferably 0.01 mass % or more and 6.0 mass % or less relative to the mass of the toner particles.

Method for Producing Toner Next, a method for producing the toners (the white toner and the color toner) according to the exemplary embodiment will be described.

The toners according to the exemplary embodiment are obtained by producing toner particles and then externally adding an external additive to the toner particles.

The toner particles may be produced by a dry process (e.g., kneading pulverization) or a wet process (e.g., aggregation and coalescence, suspension polymerization, or dissolution suspension). Not only these processes but any well-known process may be used to produce the toner particles.

Of these, the white toner particles may be produced by kneading pulverization. The color toner particles may be produced by aggregation and coalescence.

Hereinafter, examples of the kneading pulverization and the aggregation and coalescence will be described. The descriptions of the processes will be made without distinction of color.

### Kneading Pulverization

The kneading pulverization is a method for obtaining toner particles through a kneading step of melting and kneading toner-particle-forming materials (i.e., a binder resin, a colorant, etc.) to obtain a kneaded product and a pulverization step of pulverizing the kneaded product obtained.

### Kneading Step

The kneading step involves kneading of toner-particle-forming materials including a binder resin, a white colorant, etc. The toner-particle-forming materials may optionally include other additives such as a release agent.

In the kneading step, 0.5 parts by mass or more and 5 parts by mass or less of an aqueous medium (e.g., water such as distilled water or ion-exchanged water, an alcohol, or the like) may be added to 100 parts by mass of the toner-particle-forming materials.

The kneader used in the kneading step may be, for example, a single-screw extruder or a twin-screw extruder. Hereinafter, as a non-limiting example of the kneader, a kneader having feed screw sections and two kneading sections will be described with reference to a figure.

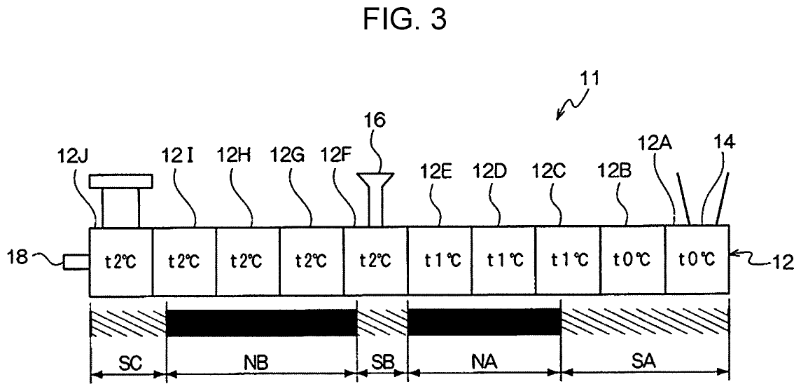

As illustrated in FIG. 3, a screw extruder 11 includes a barrel 12 provided with a screw (not illustrated), an inlet port 14 through which the toner-particle-forming materials, raw materials of a toner, are injected into the barrel 12, a liquid addition port 16 for adding an aqueous medium to the toner-particle-forming materials in the barrel 12, and a discharge port 18 through which a kneaded product formed through kneading of the toner-particle-forming materials in the barrel 12 is discharged.

The barrel 12 is divided into a feed screw section SA, a kneading section NA, a feed screw section SB, a kneading section NB, and a feed screw section SC, which are disposed in this order from the side close to the inlet port 14, the feed screw section SA transporting the toner-particle-forming materials injected through the inlet port 14 to the kneading section NA, the kneading section NA being for melt kneading the toner-particle-forming materials in a first kneading step, the feed screw section SB transporting the toner-particle-forming materials melt kneaded in the kneading section NA to the kneading section NB, the kneading section NB melt kneading the toner-particle-forming materials in a second kneading step to form a kneaded product, the feed screw section SC transporting the formed kneaded product to the discharge port 18.

The inside of the barrel 12 is provided with different temperature controllers (not illustrated) for respective blocks. That is, the barrel 12 is configured such that blocks 12A to 12J may be controlled at different temperatures.

FIG. 3 shows the temperatures of the blocks 12A and 12B being controlled at t0° C., the temperatures of the blocks 12C to 12E at t1° C., and the temperatures of the blocks 12F to 12J at t2° C. Accordingly, the toner-particle-forming materials at the kneading section NA are heated to t1° C., and the toner-particle-forming materials in the kneading section NB are heated to t2° C.

When the toner-particle-forming materials are fed into the barrel 12 through the inlet port 14, the toner-particle-forming materials are fed to the kneading section NA by the feed screw section SA. At this time, since the temperature of the block 12C is set to t1° C., the toner-particle-forming materials are fed to the kneading section NA after being heated to be in a molten state. Since the temperatures of the blocks 12D and 12E are also set to t1° C., the toner-particle-forming materials are melt kneaded at a temperature of t1° C. in the kneading section NA. The binder resin and the release agent turn into a molten state in the kneading section NA and are subjected to shear by the screw.

Next, the toner-particle-forming materials that have been kneaded in the kneading section NA are fed to the kneading section NB by the feed screw section SB.

Subsequently, at the feed screw section SB, an aqueous medium is added to the toner-particle-forming materials by injecting the aqueous medium into the barrel 12 through the liquid addition port 16.

The aqueous medium need not necessarily be injected at the feed screw section SB, and the aqueous medium may be injected at the kneading section NB, or the aqueous medium may be injected at both the feed screw section SB and the kneading section NB. That is, the position and point where the aqueous medium is injected are selected as necessary.

As a result of the injection of the aqueous medium into the barrel 12 through the liquid addition port 16, the toner-particle-forming materials in the barrel 12 and the aqueous medium are mixed together, and the toner-particle-forming materials are cooled by the latent heat of vaporization of the aqueous medium, whereby the temperature of the toner-particle-forming materials is maintained.

Finally, the kneaded product formed by the melt kneading by the kneading section NB is transported to the discharge port 18 by the feed screw section SC and discharged through the discharge port 18.

In the above manner, the kneading step using the screw extruder 11 illustrated in FIG. 3 is performed.

### Cooling Step

A cooling step is a step of cooling the melt-kneaded product formed in the above melt-kneading step, and in the cooling step, the melt-kneaded product may be cooled from the temperature of the kneaded product at the end of the kneading step to 40° C. or lower at an average temperature decrease rate of 4° C./sec or more. If the kneaded product is cooled at a slow rate, the mixture finely dispersed in the binder resin in the kneading step (the mixture of the binder resin, the colorant, etc.) may be recrystallized, resulting in a larger dispersion size. When the kneaded product is rapidly cooled at the above average temperature decrease rate, the dispersion state immediately after the kneading step is kept without change. The above average temperature decrease rate refers to the average of rates of decreasing the temperature from the temperature of the kneaded product at the end of the kneading step (e.g., t2° C. in the case where the screw extruder 11 in FIG. 3 is used) to 40° C.

A specific example of a method of cooling in the cooling step is to use reduction rollers in which cold water or brine is circulated, sandwich-type cooling belts, and the like. When the cooling is performed by this method, the cooling rate depends on the speed of the reduction rollers, the flow rate of brine, the feed rate of the kneaded product, the slab thickness of the kneaded product upon rolling, and the like. The slab thickness may be 1 mm or more and 3 mm or less.

### Pulverization Step

The kneaded product cooled in the cooling step is pulverized in the pulverization step to form into particles. In the pulverization step, for example, a mechanical pulverizer, a jet pulverizer, or the like is used. The particles may be rounded by heat treatment with hot air or the like as needed.

### Classification Step

To provide toner particles having a volume-average particle size within the desired range, the particles obtained in the pulverization step may be classified in a classification step as needed. In the classification step, a centrifugal classifier, an inertia classifier, or the like that has been used in the related art is used to remove fine powder (particles having a particle size smaller than the desired range) and coarse powder (particles having a particle size larger than the desired range).

Through the above steps, the toner particles are obtained.

### Aggregation and Coalescence

The aggregation and coalescence is a method for producing toner particles through, for example,
a step (a dispersion preparing step) of preparing dispersions,
a step (a first aggregated particle forming step) of mixing a first resin particle dispersion in which first resin particles serving as a binder resin are dispersed, a colorant dispersion in which a colorant is dispersed, and a release agent particle dispersion in which particles of a release agent (hereinafter also referred to as “release agent particles”) are dispersed to aggregate the particles and the colorant in the resulting dispersion, thereby forming first aggregated particles,
a step (a second aggregated particle forming step) of, after obtaining the first aggregated particle dispersion in which the first aggregated particles are dispersed, adding second resin particles serving as a binder resin to the first aggregated particle dispersion to aggregate the second resin particles on the surface of the first aggregated particles, thereby forming second aggregated particles, and
a step (a fusion and coalescence step) of heating the second aggregated particle dispersion in which the second aggregated particles are dispersed to fuse and coalesce the second aggregated particles, thereby forming toner particles.

Although the aggregation and coalescence will be described as a method for producing toner particles containing a binder resin, a colorant, and a release agent, the release agent is a component contained in the toner particles as needed.

Dispersion Preparing Step First, dispersions used in the aggregation and coalescence are prepared. Specifically, a first resin particle dispersion in which first resin particles serving as a binder resin are dispersed, a colorant dispersion in which a colorant is dispersed, a second resin particle dispersion in which second resin particles serving as a binder resin are dispersed, and a release agent particle dispersion in which release agent particles are dispersed are prepared.

In the dispersion preparing step, the first resin particles and the second resin particles are referred to as “resin particles”.

The resin particle dispersions are each prepared by, for example, dispersing resin particles in a dispersion medium with a surfactant.

The dispersion medium used for each resin particle dispersion may be, for example, an aqueous medium.

Examples of the aqueous medium include water, such as distilled water and ion-exchanged water, and alcohols. These may be used alone or in combination of two or more.

Examples of the surfactant include anionic surfactants such as sulfate ester salts, sulfonate salts, phosphate esters, and soaps; cationic surfactants such as amine salts and quaternary ammonium salts; and nonionic surfactants such as polyethylene glycol, alkylphenol-ethylene oxide adducts, and polyhydric alcohols. Of these, in particular, anionic surfactants and cationic surfactants may be used. Nonionic surfactants may be used in combination with an anionic surfactant or a cationic surfactant.

These surfactants may be used alone or in combination of two or more.

In preparing each resin particle dispersion, the resin particles may be dispersed in a dispersion medium by a commonly used dispersion technique, for example, a rotary shear homogenizer or a media mill such as a ball mill, a sand mill, or a Dyno-Mill. Depending on the type of the resin particles, the resin particles may be dispersed in the resin particle dispersion using, for example, phase-inversion emulsification.

Phase-inversion emulsification is a process in which a resin to be dispersed is dissolved in a hydrophobic organic solvent capable of dissolving the resin, a base is added to the organic continuous phase (O-phase) to cause neutralization, and then an aqueous medium (W-phase) is added to cause resin conversion (i.e., phase inversion) from W/O to O/W and form a discontinuous phase, whereby the resin is dispersed in particulate form in the aqueous medium.

The volume-average particle size of the resin particles dispersed in each resin particle dispersion is, for example, preferably 0.01 μm or more and 1 μm or less, more preferably 0.08 μm or more and 0.8 μm or less, still more preferably 0.1 μm or more and 0.6 μm or less.

The volume-average particle size of the resin particles is determined as follows: using a particle size distribution obtained by measurement with a laser diffraction particle size distribution analyzer (e.g., LA-700 manufactured by Horiba, Ltd.), a cumulative volume distribution is plotted against divided particle size ranges (channels) from the small particle size side, and a particle size at a cumulative percentage of 50% relative to all particles is determined as the volume-average particle size D50v. The volume-average particle sizes of particles in other dispersions are determined in the same manner.

The content of the resin particles in each resin particle dispersion is, for example, preferably 5 mass % or more and 50 mass % or less, more preferably 10 mass % or more and 40 mass % or less.

In the same manner as the resin particle dispersions, for example, the colorant dispersion and the release agent particle dispersion are also prepared. That is, the volume-average particle size of particles, the dispersion medium, the dispersion technique, and the content of the particles in the resin particle dispersion also apply to the colorant dispersed in the colorant dispersion and the release agent particles dispersed in the release agent particle dispersion.

### First Aggregated Particle Forming Step

Next, the first resin particle dispersion, the colorant dispersion, and the release agent particle dispersion are mixed together.

The first resin particles, the colorant, and the release agent particles are then allowed to undergo heteroaggregation in the mixed dispersion to form first aggregated particles containing the first resin particles, the colorant, and the release agent particles.

Specifically, the first aggregated particles are formed by, for example, adding an aggregating agent to the mixed dispersion of the first resin particle dispersion, the colorant dispersion, and the release agent particle dispersion while adjusting the mixed dispersion to an acidic pH (e.g., a pH of 2 to 5), optionally adding a dispersion stabilizer, and then bringing the temperature in the range of 20° C. or higher and 50° C. or lower to aggregate the particles dispersed in the mixed dispersion.

In the first aggregated particle forming step, for example, the heating may be performed after adding the aggregating agent to the mixed dispersion at room temperature (e.g., 25° C.) while stirring with a rotary shear homogenizer, adjusting the mixed dispersion to an acidic pH (e.g., a pH of 2 to 5), and optionally adding a dispersion stabilizer.

Examples of the aggregating agent include surfactants having polarity opposite to that of the surfactant used as a dispersant added to the mixed dispersion, inorganic metal salts, and metal complexes with a valence of two or more. In particular, when a metal complex is used as the aggregating agent, the amount of surfactant used is reduced, resulting in improved charging characteristics.

Additives that form a complex or a similar linkage together with metal ions of the aggregating agent may optionally be used. As such additives, chelating agents are suitable for use.

Examples of the inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent may be a water-soluble chelating agent. Examples of the chelating agent include oxycarboxylic acids such as tartaric acid, citric acid, and gluconic acid; iminodiacetic acid (IDA); nitrilotriacetic acid (NTA); and ethylenediaminetetraacetic acid (EDTA).

The amount of chelating agent added is, for example, preferably 0.01 parts by mass or more and 5.0 parts by mass or less, more preferably 0.1 parts by mass or more and less than 3.0 parts by mass relative to 100 parts by mass of the first resin particles.

### Second Aggregated Particle Forming Step

Next, after the first aggregated particle dispersion in which the first aggregated particles are dispersed is obtained, the second resin particle dispersion in which the second resin particles are dispersed is added to the first aggregated particle dispersion.

The second resin particles and the first resin particles may be of the same type or different types.

In the dispersion containing the first aggregated particles and the second resin particles, the second resin particles are aggregated onto the surface of the first aggregated particles. At this time, the release agent particle dispersion may also be added to aggregate the second resin particles and the release agent particles onto the surface of the first aggregated particles. Specifically, for example, when the particle size of the first aggregated particles has reached the desired particle size in the first aggregated particle forming step, the second resin particle dispersion is added to the first aggregated particle dispersion, and heating is performed at a temperature equal to or lower than the glass transition temperature of the second resin particles.

The pH of the dispersion is then adjusted to be in the range of, for example, about 6.5 to 8.5 to stop the progress of aggregation.

In this manner, the second aggregated particles in which the second resin particles are aggregated so as to adhere to the surface of the first aggregated particles are obtained.

### Fusion and Coalescence Step

Next, the second aggregated particle dispersion in which the second aggregated particles are dispersed is heated, for example, at or above the glass transition temperatures of the first and second resin particles (e.g., at or above a temperature that is 10° C. to 30° C. higher than the glass transition temperatures of the first and second resin particles) to fuse and coalesce the second aggregated particles, thereby forming toner particles.

Through the above steps, the toner particles are obtained.

In the aggregation and coalescence described above, the toner particles may be formed by fusing and coalescing the first aggregated particles without performing the second aggregated particle forming step. Alternatively, the second aggregated particle forming step may be repeatedly performed a plurality of times.

After the completion of the fusion and coalescence step, the toner particles formed in the solution are subjected to known washing, solid-liquid separation, and drying steps to obtain dry toner particles.

The washing step may be performed by sufficient displacement washing with ion-exchanged water in terms of charging characteristics. Although the solid-liquid separation step may be performed by any process, a process such as suction filtration or pressure filtration may be used in terms of productivity. Although the drying step may also be performed by any process, a process such as freeze drying, flash drying, fluidized bed drying, and vibrating fluidized bed drying may be used in terms of productivity.

In the method for producing the toners according to the exemplary embodiment, for example, an external additive may be added to and mixed with the toner particles obtained by the method for producing the toner particles described above.

The mixing may be performed with, for example, a V-blender, a Henschel mixer, or a Lodige mixer. Furthermore, coarse toner particles may be removed as needed using, for example, a vibrating sieving machine or a wind-force sieving machine.

### Electrostatic Image Developer Set

An electrostatic image developer set according to an exemplary embodiment includes a white electrostatic image developer containing the white toner included in the toner set according to the exemplary embodiment and a color electrostatic image developer containing the color toner included in the toner set for electrostatic image development according to the exemplary embodiment.

In the electrostatic image developer set according to the exemplary embodiment, each developer may be a one-component developer including only the toner of the toner set according to the exemplary embodiment or a two-component developer including a mixture of the toner and a carrier.

The carrier may be any known carrier. The carrier may be, for example, a coated carrier obtained by coating the surface of a core formed of magnetic powder with a coating resin; a magnetic-powder-dispersed carrier obtained by dispersing and blending magnetic powder in a matrix resin; or a resin-impregnated carrier obtained by impregnating porous magnetic powder with a resin.

The magnetic-powder-dispersed carrier and the resin-impregnated carrier may also be a carrier obtained by using the constituent particles of the carrier as a core and coating the core with a coating resin.

Examples of the magnetic powder include magnetic metals such as iron, nickel, and cobalt and magnetic oxides such as ferrite and magnetite.

Examples of the coating resin and the matrix resin include styrene-acrylic resins;
polyolefin resins such as polyethylene and polypropylene; polyvinyl or polyvinylidene resins such as polystyrene, (meth)acrylic resin, polyacrylonitrile, polyvinyl acetate, polyvinyl alcohol, polyvinyl butyral, polyvinyl chloride, polyvinylcarbazole, polyvinyl ether, and polyvinyl ketone; vinyl chloride-vinyl acetate copolymers; straight silicone resins having organosiloxane bonds and modified products thereof; fluorocarbon resins such as polytetrafluoroethylene, polyvinyl fluoride, polyvinylidene fluoride, and polychlorotrifluoroethylene; polyester; polyurethane; polycarbonate; amino resins such as urea-formaldehyde resin; and epoxy resins.

The coating resin and the matrix resin preferably include a (meth)acrylic resin, more preferably include an alicyclic (meth)acrylic resin in an amount of 50 mass % or more relative to the total mass of the resin, particularly preferably include a (meth)acrylic resin in an amount of 80 mass % or more relative to the total mass of the resin.

The coating resin and the matrix resin may contain conductive particles and other additives.

Examples of the conductive particles include particles of metals such as gold, silver, and copper, carbon black, titanium oxide, zinc oxide, tin oxide, barium sulfate, aluminum borate, and potassium titanate.

An example method for coating the surface of the core with the coating resin is coating with a solution for coating layer formation obtained by dissolving the coating resin and various optional additives in an appropriate solvent. Any solvent may be selected by taking into account factors such as the coating resin used and coating suitability.

Specific resin coating methods include a dipping method in which the core is dipped in the solution for coating layer formation, a spraying method in which the surface of the core is sprayed with the solution for coating layer formation, a fluidized bed method in which the core suspended in an air stream is sprayed with the solution for coating layer formation, and a kneader-coater method in which the carrier core and the solution for coating layer formation are mixed in a kneader-coater and the solvent is removed.

The mixing ratio (mass ratio) of the toner to the carrier in the two-component developer is preferably 1:100 to 30:100, more preferably 3:100 to 20:100.

### Image Forming Apparatus and Image Forming Method

An image forming apparatus and an image forming method according to an exemplary embodiment will be described.

The image forming apparatus according to the exemplary embodiment includes a first image forming unit that includes a first developing unit containing the white electrostatic image developer included in the developer set according to the exemplary embodiment and that forms a white image, a second image forming unit that includes a second developing unit containing the color electrostatic image developer included in the developer set according to the exemplary embodiment and that forms a color image with the color toner, a transfer unit that transfers the white image and the color image to a surface of a recording medium, and a fixing unit that fixes the white image and the color image transferred to the surface of the recording medium.

The image forming apparatus according to the exemplary embodiment may include, as the first and second image forming units, image forming units each including an image carrying member, a charging unit that charges a surface of the image carrying member, an electrostatic image forming unit that forms an electrostatic image on the charged surface of the image carrying member, and a developing unit that develops the electrostatic image formed on the surface of the image carrying member with the electrostatic image developer to form a toner image.

The image forming apparatus according to the exemplary embodiment may include an image carrying member, a charging unit that charges a surface of the image carrying member, an electrostatic image forming unit that forms an electrostatic image on the charged surface of the image carrying member, and, as the first and second image forming units, first and second developing units that develop the electrostatic image formed on the surface of the image carrying member with the electrostatic image developer to form a toner image.

The image forming apparatus according to the exemplary embodiment executes an image forming method (an image forming method according to an exemplary embodiment) including forming the white image using the white toner of the toner set for electrostatic image development according to the exemplary embodiment, forming a color image with the color toner of the toner set for electrostatic image development according to the exemplary embodiment, transferring the white image and the color image onto a recording medium, and fixing the white image and the color image on the recording medium.

The image forming apparatus according to the exemplary embodiment may be a well-known image forming apparatus: for example, a direct-transfer apparatus that transfers a toner image (a white image and a color image in the exemplary embodiment) formed on a surface of an image carrying member directly to a recording medium; an intermediate-transfer apparatus that performs first transfer of a toner image formed on a surface of an image carrying member to a surface of an intermediate transfer body and then performs second transfer of the toner image transferred to the surface of the intermediate transfer body to a surface of a recording medium; an apparatus including a cleaning unit that cleans a surface of an image carrying member after the transfer of a toner image and before charging; or an apparatus including an erasing unit that erases charge on a surface of an image carrying member by irradiation with erasing light after the transfer of a toner image and before charging.

In the case of an intermediate-transfer apparatus, the transfer unit has a configuration including, for example, an intermediate transfer body having a surface to which a toner image is transferred, a first transfer unit that performs first transfer of a toner image formed on a surface of an image carrying member to the surface of the intermediate transfer body, and a second transfer unit that performs second transfer of the toner image transferred to the surface of the intermediate transfer body to a surface of a recording medium.

In the image forming apparatus according to the exemplary embodiment, the section including the developing unit may be, for example, a cartridge structure (process cartridge) attachable to and detachable from the image forming apparatus. As the process cartridge, for example, a process cartridge including a developing unit containing the electrostatic image developer set according to the exemplary embodiment is suitable for use.

The image forming apparatus according to the exemplary embodiment may be an image forming apparatus that contains the white toner included in the toner set according to the exemplary embodiment in a developing unit and contains, as the color toner, at least one selected from a yellow toner, a magenta toner, a cyan toner, and a black toner in the developing unit.

The recording medium on which an image is to be recorded using the image forming apparatus (image forming method) according to the exemplary embodiment may be any known recording medium. Examples include resin films or sheets and papers. Applications of the resin films or sheets include packages, labels, packaging materials, advertising media, and OHP sheets.

The resin films or sheets include polyolefin films or sheets of polyethylene, polypropylene, and the like; polyester films or sheets of polyethylene terephthalate, polybutylene terephthalate, and the like; polyamide films or sheets of nylon and the like; and films or sheets of polycarbonate, polystyrene, modified polystyrene, polyvinyl chloride, polyvinyl alcohol, polylactic acid, and the like. These films or sheets may be unstretched films or sheets or uniaxially stretched or biaxially stretched films or sheets. The resin films or sheets may have a monolayer or multilayer structure. The resin films or sheets may be films having a surface coat layer that aids toner fixation or films or sheets subjected to corona treatment, ozone treatment, plasma treatment, frame treatment, glow discharge treatment, or the like.

Examples of the stacking order of the recording medium, the color image, and the white image (hiding layer) include the following (a), (b), and (c).
Stacking order (a): from the side close to the viewer, transparent recording medium/color image/white image (hiding layer)
Stacking order (b): from the side close to the viewer, color image/transparent recording medium/white image (hiding layer)
Stacking order (c): from the side close to the viewer, color image/white image (hiding layer)/recording medium (either transparent or non-transparent)

A non-limiting example of the image forming apparatus according to the exemplary embodiment will be described below. Main parts illustrated in the drawings are described, and the description of other parts is omitted.

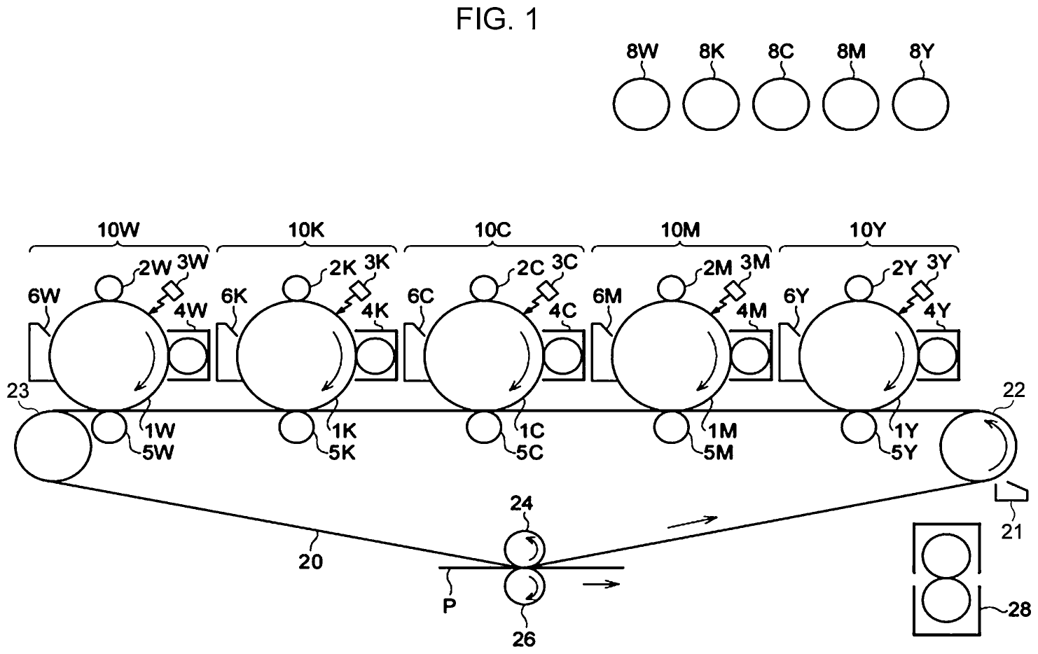

FIG. 1 illustrates a schematic configuration of the image forming apparatus according to the exemplary embodiment, and illustrates an image forming apparatus that employs a five-unit tandem system and an intermediate transfer system.

The image forming apparatus illustrated in FIG. 1 includes first to fifth electrophotographic image forming units 10Y, 10M, 10C, 10K, and 10W which respectively output yellow (Y), magenta (M), cyan (C), black (K), and white (W) images based on color-separated image data. These image forming units (hereinafter also referred to simply as “units”) 10Y, 10M, 10C, 10K, and 10W are arranged side by side at predetermined intervals from each other in the horizontal direction. These units 10Y, 10M, 10C, 10K, and 10W may be process cartridges attachable to and detachable from the image forming apparatus.

An intermediate transfer belt 20 (an example of the intermediate transfer body) extends below the units 10Y, 10M, 10C, 10K, and 10W so as to pass through the units. The intermediate transfer belt 20 is wound around a drive roller 22, a support roller 23, and a counter roller 24, which are in contact with the inner surface of the intermediate transfer belt 20, and is configured to run in the direction from the first unit 10Y toward the fifth unit 10W. An intermediate transfer body cleaning device 21 is provided on the image carrying member side of the intermediate transfer belt 20 so as to face the drive roller 22.

The units 10Y, 10M, 10C, 10K, and 10W respectively include developing devices 4Y, 4M, 4C, 4K, and 4W (examples of the developing unit) to which yellow, magenta, cyan, black, and white toners are respectively supplied from toner cartridges 8Y, 8M, 8C, 8K, and 8W.

The first to fifth units 10Y, 10M, 10C, 10K, and 10W have the same configuration, operation, and function and thus the first unit 10Y, which is disposed upstream in the running direction of the intermediate transfer belt and forms a yellow image, will be described here as a representative.

The first unit 10Y includes a photoreceptor 1Y, which functions as an image carrying member. The photoreceptor 1Y is surrounded by, in sequence, a charging roller 2Y (an example of the charging unit), which charges the surface of the photoreceptor 1Y to a predetermined potential, an exposure device 3Y (an example of the electrostatic image forming unit), which exposes the charged surface to a laser beam based on a color-separated image signal to form an electrostatic image, a developing device 4Y (an example of the developing unit), which supplies a toner to the electrostatic image to develop the electrostatic image, a first transfer roller 5Y (an example of the first transfer unit), which transfers the developed toner image onto the intermediate transfer belt 20, and a photoreceptor cleaning device 6Y (an example of the cleaning unit), which removes the toner remaining on the surface of the photoreceptor 1Y after the first transfer.

The first transfer roller 5Y is disposed inside the intermediate transfer belt 20 so as to face the photoreceptor 1Y. The first transfer rollers 5Y, 5M, 5C, 5K, and 5W of the units are each connected to a bias power supply (not shown) that applies a first transfer bias. The value of transfer bias applied from each bias power supply to each first transfer roller is changed by control of a controller (not shown).

The operation of the first unit 10Y to form a yellow image will be described below. Prior to the operation, the charging roller 2Y charges the surface of the photoreceptor 1Y to a potential of −600 V to −800 V.

The photoreceptor 1Y is formed of a conductive substrate (for example, having a volume resistivity of 1×10⁻⁶ Ωcm or less at 20° C.) and a photosensitive layer stacked on the substrate. The photosensitive layer, which normally has high resistivity (resistivity of common resins), has the property of, upon irradiation with a laser beam, changing its resistivity in an area irradiated with the laser beam. The exposure device 3Y applies a laser beam to the charged surface of the photoreceptor 1Y on the basis of yellow image data sent from the controller (not shown). As a result, an electrostatic image with a yellow image pattern is formed on the surface of the photoreceptor 1Y.

The electrostatic image is an image formed on the surface of the photoreceptor 1Y by charging, i.e., a negative latent image formed in the following manner: in the area of the photosensitive layer irradiated with a laser beam from the exposure device 3Y, the resistivity decreases, and the charge on the surface of the photoreceptor 1Y dissipates from the area, while the charge remains in the area not irradiated with the laser beam.

As the photoreceptor 1Y runs, the electrostatic image formed on the photoreceptor 1Y is rotated to a predetermined development position. At the development position, the electrostatic image on the photoreceptor 1Y is developed by the developing device 4Y to form a visible toner image.

The developing device 4Y contains, for example, an electrostatic image developer containing at least a yellow toner and a carrier. The yellow toner is frictionally charged as it is stirred inside the developing device 4Y, and thus has a charge with the same polarity (negative) as that of the charge on the photoreceptor 1Y and is held on a developer roller (an example of the developer holding member). As the surface of the photoreceptor 1Y passes through the developing device 4Y, the yellow toner is electrostatically attached to the neutralized latent image portion on the surface of the photoreceptor 1Y, so that the latent image is developed with the yellow toner. The photoreceptor 1Y on which the yellow toner image is formed continues to run at a predetermined speed, and the toner image developed on the photoreceptor 1Y is transported to a predetermined first transfer position.

When the yellow toner image on the photoreceptor 1Y is transported to the first transfer position, a first transfer bias is applied to the first transfer roller 5Y, and electrostatic force directed from the photoreceptor 1Y toward the first transfer roller 5Y acts on the toner image to transfer the toner image on the photoreceptor 1Y onto the intermediate transfer belt 20. The transfer bias applied at this time has polarity (positive) opposite to the polarity (negative) of the toner and is controlled to, for example, +10 μA by the controller (not shown) in the first unit 10Y.

The toner remaining on the photoreceptor 1Y is removed and collected by the photoreceptor cleaning device 6Y.

The first transfer biases applied to the first transfer rollers 5M, 5C, 5K, and 5W of the second to fifth units 10M, 10C, 10K, and 10W are controlled in the same manner as in the first unit.

Thus, the intermediate transfer belt 20 to which the yellow toner image is transferred by the first unit 10Y is sequentially transported through the second to fifth units 10M, 10C, 10K, and 10W, and as a result, toner images of the respective colors are transferred in a superimposed manner.

The intermediate transfer belt 20, to which the toner images of the five colors are transferred in a superimposed manner through the first to fifth units, runs to a second transfer section including the intermediate transfer belt 20, the counter roller 24 in contact with the inner surface of the intermediate transfer belt, and a second transfer roller 26 (an example of the second transfer unit) disposed on the image carrying member side of the intermediate transfer belt 20. A sheet of recording paper P (an example of the recording medium) is fed into the nip between the second transfer roller 26 and the intermediate transfer belt 20 at a predetermined timing by a feed mechanism, and a second transfer bias is applied to the counter roller 24. The transfer bias applied at this time has the same polarity (negative) as the polarity (negative) of the toner, and electrostatic force directed from the intermediate transfer belt 20 toward the recording paper P acts on the toner image to transfer the toner image on the intermediate transfer belt 20 onto the recording paper P. The second transfer bias at this time is determined depending on the resistance detected by a resistance detector (not shown) that detects the resistance of the second transfer section, and is voltage-controlled.

The recording paper P is then sent to a pressure-contact part (nip part) between a pair of fixing rollers of a fixing device 28 (an example of the fixing unit), and the toner image is fixed onto the recording paper P, thus forming a fixed image.

Examples of the recording paper P to which the toner image is transferred include plain paper for use in electrophotographic copiers, printers, and other devices. Examples of recording media other than the recording paper P include OHP sheets.

To further improve the surface smoothness of the fixed image, the surface of the recording paper P may also be smooth, and for example, coated paper, i.e., plain paper coated with resin or the like and art paper for printing are suitable for use.

The recording paper P after completion of the fixing of the color image is conveyed to a discharge unit, completing the series of color image forming operations.

### Process Cartridge/Toner Cartridge Set

A process cartridge according to an exemplary embodiment will be described.

The process cartridge according to the exemplary embodiment is a process cartridge that includes a first developing unit containing the white electrostatic image developer of the electrostatic image developer set according to the exemplary embodiment and a second developing unit containing the color electrostatic image developer of the electrostatic image developer set according to the exemplary embodiment, and that is attachable to and detachable from an image forming apparatus.

The process cartridge according to the exemplary embodiment need not necessarily have the above configuration and may have a configuration including a developing device and optionally at least one selected from other units such as an image carrying member, a charging unit, an electrostatic image forming unit, and a transfer unit.

A non-limiting example of the process cartridge according to the exemplary embodiment will be described below. Main parts illustrated in the drawings are described, and the description of other parts is omitted.

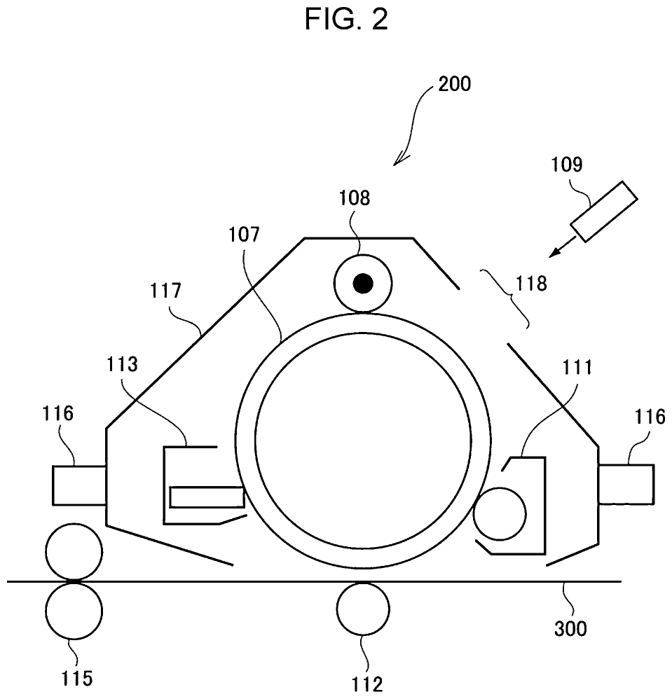

FIG. 2 illustrates a schematic configuration of the process cartridge according to the exemplary embodiment.

A process cartridge 200 illustrated in FIG. 2 is configured as a cartridge, for example, such that a photoreceptor 107 (an example of the image carrying member), a charging roller 108 (an example of the charging unit) disposed on the periphery of the photoreceptor 107, a developing device 111 (an example of the developing unit), and a photoreceptor cleaning device 113 (an example of the cleaning unit) are integrally combined and held by a housing 117 provided with mounting rails 116 and an opening 118 for exposure.

In FIG. 2, 109 represents an exposure device (an example of the electrostatic image forming unit), 112 represents a transfer device (an example of the transfer unit), 115 represents a fixing device (an example of the fixing unit), and 300 represents recording paper (an example of the recording medium).

Next, a toner cartridge set according to an exemplary embodiment will be described.

The toner cartridge set according to the exemplary embodiment is a toner cartridge set including a white toner cartridge that contains the white toner included in the toner set according to the exemplary embodiment and that is attachable to and detachable from an image forming apparatus and a color toner cartridge that contains the color toner included in the toner set according to the exemplary embodiment and that is attachable to and detachable from the image forming apparatus. The toner cartridge set contains replenishment toner to be supplied to a developing unit provided in the image forming apparatus.

The image forming apparatus illustrated in FIG. 2 is configured such that the toner cartridges 8Y, 8M, 8C, 8K, and 8W are attachable thereto and detachable therefrom, and the developing devices 4Y, 4M, 4C, 4K, and 4W are connected to the toner cartridges corresponding to the developing devices (colors) through toner supply tubes (not shown). The toner cartridges are replaced when the amount of toner therein is decreased.

### Examples

The exemplary embodiments of the disclosure will now be described in detail with reference to Examples, but these Examples are not intended to limit the exemplary embodiments of the disclosure. In the following description, “parts” and “%” are by mass unless otherwise specified.

### Preparation of Dispersions

### Synthesis of Amorphous Polyester Resin (A)

Terephthalic acid: 68 parts
Fumaric acid: 32 parts
Ethylene glycol: 42 parts
1,5-Pentanediol: 47 parts

The above materials are placed in a flask equipped with a stirring device, a nitrogen inlet tube, a temperature sensor, and a rectifying column, the temperature is raised to 220° C. over 1 hour under a stream of nitrogen gas, and 1 part of titanium tetraethoxide is added to a total of 100 parts of the above materials. The temperature is raised to 240° C. over 0.5 hours while produced water is distilled off, and after the dehydration condensation reaction is continued at 240° C. for 1 hour, the reaction product is cooled. Thus, an amorphous polyester resin (A) having a weight-average molecular weight of 97,000 and a glass transition temperature of 60° C. is obtained.

### Preparation of Amorphous Polyester Resin Particle Dispersion (A1)

After 40 parts of ethyl acetate and 25 parts of 2-butanol are placed in a vessel equipped with a temperature control unit and a nitrogen purging unit to form a mixed solvent, 100 parts of the amorphous polyester resin (A) is gradually added and dissolved, to which a 10% aqueous ammonia solution (3 molar equivalents with respect to the acid value of the resin) is added, and stirring is performed for 30 minutes. Subsequently, the vessel is purged with dry nitrogen, and while the mixed solution is stirred at a constant temperature of 40° C., 400 parts of ion-exchanged water is added dropwise to cause emulsification. After completion of the dropwise addition, the emulsion is returned to 25° C. to obtain a resin particle dispersion in which resin particles having a volume-average particle size of 195 nm are dispersed. Ion-exchanged water is added to the resin particle dispersion to adjust the solid content to 20%, thereby obtaining an amorphous polyester resin particle dispersion (A1).

### Preparation of Crystalline Polyester Resin Particle Dispersion (B1)

1,10-Decanedicarboxylic acid: 260 parts
1,6-Hexanediol: 167 parts
Dibutyl tin oxide (catalyst): 0.3 parts

The above materials are placed in a three-necked flask dried by heating, the three-necked flask is purged with nitrogen gas to create an inert atmosphere, and reflux is performed under mechanical stirring at 180° C. for 5 hours. Subsequently, the temperature is gradually increased to 230° C. under reduced pressure while stirring is performed for 2 hours, and when becoming viscous, the mixture is air-cooled to stop the reaction. Thus, a crystalline polyester resin having a weight-average molecular weight of 12,500 and a melting temperature of 73° C. is obtained. Ninety parts of the crystalline polyester resin, 1.8 parts of an anionic surfactant (TaycaPower manufactured by TAYCA CORPORATION; solid content, 12%; sodium dodecylbenzene sulfonate), and 210 parts of ion-exchanged water are mixed and heated to 120° C., and the mixture is dispersed using a homogenizer (ULTRA-TURRAX T50 manufactured by IKA), after which dispersion treatment is performed for 1 hour using a pressure discharge GAULIN homogenizer to obtain a resin particle dispersion in which resin particles having a volume-average particle size of 195 nm are dispersed. Ion-exchanged water is added to the resin particle dispersion to adjust the solid content to 20%, thereby obtaining a crystalline polyester resin particle dispersion (B1).

### Preparation of Styrene-Acrylic Resin Particle Dispersion (S1)

Styrene: 375 parts
n-Butyl acrylate: 25 parts
Acrylic acid: 2 parts
Dodecanethiol: 24 parts
Carbon tetrabromide: 4 parts

In a flask, a mixture obtained by mixing and dissolving the above materials is dispersed and emulsified in a surfactant solution of 6 parts of a nonionic surfactant (NONIPOL 400 manufactured by Sanyo Chemical Industries, Ltd.) and 10 parts of an anionic surfactant (TaycaPower manufactured by TAYCA CORPORATION; solid content, 12%; sodium dodecylbenzene sulfonate) in 550 parts of ion-exchanged water. Subsequently, an aqueous solution of 4 parts of ammonium persulfate in 50 parts by mass of ion-exchanged water is put into the flask over 20 minutes while the contents of the flask are stirred. Subsequently, after nitrogen purging is performed, the inside of the flask is heated with stirring in an oil bath until the temperature of the contents reaches 70° C., and the emulsion polymerization is continued with the temperature held at 70° C. for 5 hours. Thus, a resin particle dispersion in which resin particles having a volume-average particle size of 150 nm are dispersed is obtained. Ion-exchanged water is added to the resin particle dispersion to adjust the solid content to 20%, thereby obtaining a styrene-acrylic resin particle dispersion (S1).

### Preparation of Colorant Dispersion (Cy1)

C.I. pigment blue 15:3 (manufactured by Dainichiseika Color & Chemicals Mfg. Co., Ltd.): 70 parts
Anionic surfactant (Neogen RK manufactured by DKS Co., Ltd.): 1 part
Jon-exchanged water: 200 parts

The above materials are mixed, and the mixture is dispersed for 10 minutes using a homogenizer (ULTRA-TURRAX T50 manufactured by IKA). Ion-exchanged water is added such that the dispersion has a solid content of 20% to obtain a colorant dispersion (Cy1) in which colorant particles having a volume-average particle size of 190 nm are dispersed.

### Preparation of Release Agent Particle Dispersion (W1)

Ester wax (WEP-8 manufactured by NOF Corporation; melting temperature, 79° C.): 100 parts
Anionic surfactant: 1 part
   (TaycaPower manufactured by TAYCA CORPORATION; solid content, 12%; sodium dodecylbenzene sulfonate)
Ion-exchanged water: 350 parts

The above materials are mixed and heated to 100° C., and the mixture is dispersed using a homogenizer (ULTRA-TURRAX T50 manufactured by IKA), after which dispersion treatment is performed using a pressure discharge GAULIN homogenizer to obtain a release agent particle dispersion in which release agent particles having a volume-average particle size of 1000 nm are dispersed. Ion-exchanged water is added to the release agent particle dispersion to adjust the solid content to 20%, thereby preparing a release agent particle dispersion (W1).

### Preparation of Styrene-Acrylic-Modified Polyester Resin Particle Dispersion (SPE1)

A four-necked flask equipped with a nitrogen inlet tube, a dewatering tube, a stirrer, and a thermocouple is purged with nitrogen and charged with 5,670 parts of polyoxypropylene(2.2)-2,2-bis(4-hydroxyphenyl)propane, 585 parts of polyoxyethylene(2.0)-2,2-bis(4-hydroxyphenyl)propane, 2,450 parts of terephthalic acid, and 44 parts of tin(II) di(2-ethylhexanoate), and in a nitrogen atmosphere, the temperature is raised to 235° C. with stirring and held for 5 hours, after which the pressure in the flask is further reduced and held at 8.0 kPa for 1 hour. After being returned to the atmospheric pressure, the flask is cooled to 190° C., held at a temperature of 190° C. for 2 hours with 42 parts of fumaric acid and 207 parts of trimellitic acid added, and then heated to 210° C. over 2 hours. The pressure in the flask is further reduced and held at 8.0 kPa for 4 hours to obtain an amorphous polyester resin A (polyester segment).

Next, 800 parts of the amorphous polyester resin A is added to a four-necked flask equipped with a condenser tube, a stirring device, and a thermocouple and stirred at a stirring speed of 200 rpm in a nitrogen atmosphere. Thereafter, as addition-polymerizable monomers, 100 parts of styrene, 82 parts of ethyl acrylate, 16 parts of acrylic acid, 2 parts of 1,10-decanediol diacrylate, and 1,000 parts of toluene are added and further mixed for 30 minutes.

Furthermore, 6 parts of polyoxyethylene alkyl ether (nonionic surfactant, trade name: EMULGEN 430, manufactured by Kao Corporation), 40 parts of a 15% aqueous sodium dodecylbenzene sulfonate solution (anionic surfactant, trade name: NEOPELEX G-15, manufactured by Kao Corporation), and 233 parts of 5% potassium hydroxide are added, melted at an elevated temperature of 95° C. with stirring, and mixed at 95° C. for 2 hours to obtain a resin mixture solution.

Next, while the resin mixture solution is stirred, 1,145 parts of deionized water is added dropwise at a rate of 6 parts/min to obtain an emulsion. Next, the emulsion obtained is cooled to 25° C. and passed through a 200-mesh metal screen, and deionized water is added to adjust the solid content to 20%, thereby obtaining a styrene-acrylic-modified polyester resin particle dispersion (SPE1).

In the styrene-acrylic-modified polyester resin synthesized, “the mass ratio between the styrene-acrylic resin segment and the polyester resin segment (styrene-acrylic resin segment/polyester resin segment)” is 20/80.

Preparation of Styrene-Acrylic-Modified Polyester Resin Particle Dispersion (SPE101) A styrene-acrylic-modified polyester resin particle dispersion (SPE101) is obtained in the same manner as the styrene-acrylic-modified polyester resin particle dispersion (SPE1) except that the solid content is adjusted to 30%.

### Preparation of White Colorant

### Preparation of Titanium Oxide Particles (T1)

To 100 mL of a 1 mol/L aqueous titanium tetrachloride solution, 0.15 mol of glycerol is added, and the mixture is heated at 90° C. for 4 hours and then filtered. The white powder obtained is dispersed in 100 mL of ion-exchanged water and heated again at 90° C. for 3 hours with 0.4 mol of hydrochloric acid added. After the pH is adjusted to 7 with sodium hydroxide, filtration is performed, and the filter residue is washed with water and dried at 105° C. for 12 hours to obtain hydrous titanium dioxide particles (1). With 100 parts of the hydrous titanium dioxide particles (1), 0.25 parts of Al₂O₃, 0.1 parts of aluminum sulfate, 1.2 parts of K₂O, and 0.01 parts of P₂O₅ are mixed, and the mixture is fired at 950° C. for 2 hours to obtain titanium oxide particles (T1) having a number-average particle size Dcc of 500 nm.

### Preparation of Titanium Oxide Particles (T2)

Titanium oxide particles (T2) having a number-average particle size Dcc of 220 nm are obtained in the same manner as the titanium oxide particles (T1) except that the amount of P₂O₅ is 0.05 parts, and the firing temperature is 930° C.

### Preparation of Titanium Oxide Particles (T3)

Titanium oxide particles (T3) having a number-average particle size of 155 nm are obtained in the same manner as the titanium oxide particles (T1) except that the amount of P₂O₅ is 0.1 parts, the amount of K₂O is 0.5 parts, and the firing temperature is 920° C.

### Preparation of Titanium Oxide Particles (T4)

Titanium oxide particles (T4) having a number-average particle size Dcc of 570 nm are obtained in the same manner as the titanium oxide particles (T1) except that the amount of P₂O₅ is 0.005 parts, the amount of K₂O is 1.2 parts, the firing temperature is 970° C., and the firing time is 3 hours.

### Preparation of White Colorant (MT1)

Thirty parts of the titanium oxide particles (T1) and 70 parts of the titanium oxide particles (T2) are mixed with 200 parts of ion-exchanged water adjusted to pH 4 with a 0.1 N hydrogen chloride solution, and the mixture is then dispersed overnight in a ball mill. Thereafter, the mixture is allowed to stand, the supernatant is removed, the resultant is dried with a vacuum freeze dryer for 12 hours and then crushed with a jet mill, and the resultant is sifted to remove coarse powder. In this manner, a white colorant (MT1) having a number-average particle size Dcc of 280 nm is obtained.

### Preparation of White Colorants (MT2) to (MT16)

The titanium oxide particles (T1) in an addition amount A (parts) shown in Table 3, the titanium oxide particles (T2) in an addition amount B (parts) shown in Table 3, and the titanium oxide particles (T3) in an addition amount C (parts) shown in Table 3 are mixed with 200 parts of ion-exchanged water adjusted to pH 4 with a 0.1 N hydrogen chloride solution, and the mixture is then dispersed overnight in a ball mill. Thereafter, the mixture is allowed to stand, the supernatant is removed, the resultant is dried with a vacuum freeze dryer for 12 hours and then crushed with a jet mill, and the resultant is sifted to remove coarse powder. In this manner, white colorants (MT2) to (MT16) having number-average particle sizes Dcc shown in Table 3 are obtained.

### Preparation of White Colorant (MT17)

One hundred parts of the titanium oxide particles (T4) is mixed with 200 parts of ion-exchanged water adjusted to pH 4 with a 0.1 N hydrogen chloride solution, and the mixture is then dispersed overnight in a ball mill. Thereafter, the mixture is allowed to stand, the supernatant is removed, the resultant is dried with a vacuum freeze dryer for 12 hours and then crushed with a jet mill, and the resultant is sifted to remove coarse powder. In this manner, a white colorant (MT17) having a number-average particle size Dcc of 525 nm is obtained.

### Production of Color Toners

### Production of Cyan Toner (CT1)

### First Aggregated Particle Forming Step

Ion-exchanged water: 200 parts
Colorant dispersion (Cy1): 15 parts
Release agent particle dispersion (W1): 10 parts
Styrene-acrylic resin particle dispersion (S1): 60 parts
Crystalline polyester resin particle dispersion (B1): 10 parts
Amorphous polyester resin particle dispersion (A1): 310 parts

The above materials are placed in a round stainless-steel flask, and after 0.1 N (0.1 mol/L) nitric acid is added to adjust the pH to 3.5, an aqueous magnesium chloride solution in which 6 parts of magnesium chloride is dissolved in 30 parts of ion-exchanged water is added. The resulting mixture is dispersed at 30° C. using a homogenizer (ULTRA-TURRAX T50 manufactured by IKA), then heated to 45° C. in a heating oil bath, and held there until the volume-average particle size reaches 4.5 μm.

### Second Aggregated Particle Forming Step

Subsequently, 5 parts of the styrene-acrylic resin particle dispersion (S1) is added dropwise, and the mixture is held for 30 minutes. The addition of 5 parts of the styrene-acrylic resin particle dispersion (S1) is performed a total of four times every 30 minutes. Thereafter, while stirring is continued, the pH is adjusted to 9.0 using a 1 N aqueous sodium hydroxide solution.

### Fusion and Coalescence Step

Subsequently, while stirring is continued, the resultant is heated to 85° C. at a heating rate of 0.5° C./min, held at 85° C. for 3 hours, and then cooled to 30° C. at 15° C./min (first cooling). Subsequently, the resultant is heated to 85° C. at a heating rate of 0.2° C./min (reheating), held for 30 minutes, and then cooled to 30° C. at 0.5° C./min (second cooling).

Subsequently, solid matter is separated by filtration, washed with ion-exchanged water, and dried to obtain cyan toner particles (CT1) having a volume-average particle size of 4.7 μm.

### External Addition of External Additive

One hundred parts of the cyan toner particles (CT1) and 1.5 parts of hydrophobic silica (RY50 manufactured by Nippon Aerosil Co., Ltd.) are mixed using a sample mill at a rotation speed of 10,000 rpm for 30 seconds. The mixture is sifted through a vibrating screen with 45 μm openings to obtain a cyan toner (CT1).

### Production of Cyan Toner (CT2)

A cyan toner (CT2) is obtained in the same manner as the cyan toner (CT1) except that in the first aggregated particle forming step, the amount of the styrene-acrylic resin particle dispersion (S1) is 220 parts, and the amount of the amorphous polyester resin particle dispersion (A1) is 150 parts.

### Production of Cyan Toner (CT3)

A cyan toner (CT3) is obtained in the same manner as the cyan toner (CT1) except that in the first aggregated particle forming step, the amount of the styrene-acrylic resin particle dispersion (S1) is 16.4 parts, and the amount of the amorphous polyester resin particle dispersion (A1) is 353.6 parts.

### Production of Cyan Toner (CT4)

A cyan toner (CT4) is obtained in the same manner as the cyan toner (CT1) except that in the first aggregated particle forming step, the amount of the styrene-acrylic resin particle dispersion (S1) is 113.3 parts, and the amount of the amorphous polyester resin particle dispersion (A1) is 256.7 parts.

### Production of Cyan Toner (CT5)

A cyan toner (CT5) is obtained in the same manner as the cyan toner (CT1) except that in the first aggregated particle forming step, the amount of the styrene-acrylic resin particle dispersion (S1) is 37.1 parts, and the amount of the amorphous polyester resin particle dispersion (A1) is 332.9 parts.

### Production of Cyan Toner (CT6)

A cyan toner (CT6) is obtained in the same manner as the cyan toner (CT1) except that in the first aggregated particle forming step, the amount of the styrene-acrylic resin particle dispersion (S1) is 38.1 parts, and the amount of the amorphous polyester resin particle dispersion (A1) is 331.9 parts.

### Production of Cyan Toner (CT7)

A cyan toner (CT7) is obtained in the same manner as the cyan toner (CT1) except that in the first aggregated particle forming step, the amount of the styrene-acrylic resin particle dispersion (S1) is 32.2 parts, and the amount of the amorphous polyester resin particle dispersion (A1) is 337.8 parts.

### Production of Cyan Toner (CT8)

A cyan toner (CT8) is obtained in the same manner as the cyan toner (CT1) except that in the first aggregated particle forming step, the amount of the styrene-acrylic resin particle dispersion (S1) is 180 parts, and the amount of the amorphous polyester resin particle dispersion (A1) is 190 parts.

### Production of Cyan Toner (CT9)

A cyan toner (CT9) is obtained in the same manner as the cyan toner (CT1) except that in the first aggregated particle forming step, the styrene-acrylic resin particle dispersion (S1) and the amorphous polyester resin particle dispersion (A1) are replaced with 380 parts of the styrene-acrylic-modified polyester resin particle dispersion (SPE1), and in the second aggregated particle forming step, the styrene-acrylic resin particle dispersion (S1) is replaced with an equal amount of the styrene-acrylic-modified polyester resin particle dispersion (SPE1).

### Production of Cyan Toner (CT10)

A cyan toner (CT10) is obtained in the same manner as the cyan toner (CT1) except that in the first aggregated particle forming step, the amount of the styrene-acrylic resin particle dispersion (S1) is 343.6 parts, and the amount of the amorphous polyester resin particle dispersion (A1) is 26.4 parts.

### Production of Cyan Toner (CT11)

A cyan toner (CT11) is obtained in the same manner as the cyan toner (CT1) except that in the first aggregated particle forming step, the amount of the styrene-acrylic resin particle dispersion (S1) is 5 parts, and the amount of the amorphous polyester resin particle dispersion (A1) is 365 parts.

### Production of Cyan Toner (CT101)

A cyan toner (CT101) is obtained in the same manner as the cyan toner (CT1) except that in the first aggregated particle forming step, the amount of the styrene-acrylic resin particle dispersion (S1) is 40 parts, and the amount of the amorphous polyester resin particle dispersion (A1) is 230 parts, and in the fusion and coalescence step, the rate of heating to 85° C. is 0.05° C./min.

### Production of Cyan Toner (CT102)

A cyan toner (CT102) is obtained in the same manner as the cyan toner (CT101) except that in the first aggregated particle forming step, the amount of the styrene-acrylic resin particle dispersion (S1) is 160 parts, and the amount of the amorphous polyester resin particle dispersion (A1) is 110 parts.

### Production of Cyan Toner (CT103)

A cyan toner (CT103) is obtained in the same manner as the cyan toner (CT101) except that in the first aggregated particle forming step, the amount of the styrene-acrylic resin particle dispersion (S1) is 80 parts, and the amount of the amorphous polyester resin particle dispersion (A1) is 190 parts.

### Production of Cyan Toner (CT104)

A cyan toner (CT104) is obtained in the same manner as the cyan toner (CT101) except that in the first aggregated particle forming step, the amount of the styrene-acrylic resin particle dispersion (S1) is 25 parts, and the amount of the amorphous polyester resin particle dispersion (A1) is 250 parts.

### Production of Cyan Toner (CT105)

A cyan toner (CT105) is obtained in the same manner as the cyan toner (CT101) except that in the first aggregated particle forming step, the amount of the styrene-acrylic resin particle dispersion (S1) is 5 parts, and the amount of the amorphous polyester resin particle dispersion (A1) is 265 parts.

### Production of Cyan Toner (CT106)

A cyan toner (CT106) is obtained in the same manner as the cyan toner (CT101) except that in the first aggregated particle forming step, the amount of the styrene-acrylic resin particle dispersion (S1) is 17 parts, and the amount of the amorphous polyester resin particle dispersion (A1) is 100 parts.

### Production of Cyan Toner (CT107)

A cyan toner (CT107) is obtained in the same manner as the cyan toner (CT101) except that in the first aggregated particle forming step, the amount of the styrene-acrylic resin particle dispersion (S1) is 0 parts, and the amount of the amorphous polyester resin particle dispersion (A1) is 270 parts.

### Production of Cyan Toner (CT108)

A cyan toner (CT108) is obtained in the same manner as the cyan toner (CT101) except that in the first aggregated particle forming step, the styrene-acrylic resin particle dispersion (S1) and the amorphous polyester resin particle dispersion (A1) are replaced with 270 parts of the styrene-acrylic-modified polyester resin particle dispersion (SPE1).

### Production of Cyan Toner (CT109)

A cyan toner (CT109) is obtained in the same manner as the cyan toner (CT101) except that in the first aggregated particle forming step, the amount of the styrene-acrylic resin particle dispersion (S1) is 0 parts, and the amount of the amorphous polyester resin particle dispersion (A1) is 270 parts, and in the second aggregated particle forming step, the styrene-acrylic resin particle dispersion (S1) is replaced with the amorphous polyester resin particle dispersion (A1).

### Production of White Toners

### Production of White Toner (WT1)

### Provision of Toner-Particle-Forming Materials

The following materials are provided as toner-particle-forming materials.
Polyester resin (a polyester resin composed mainly of propylene oxide (2 mol) adduct/ethylene oxide (2 mol) adduct of bisphenol A, terephthalic acid, and trimellitic acid and synthesized using a tin catalyst): 100 parts
Styrene-acrylic resin (a resin obtained by polymerizing styrene and butyl acrylate under cumene reflux): 15 parts
White colorant (titanium oxide particles (manufactured by Ishihara Sangyo Kaisha, Ltd., product name: CR-60-2)): 80 parts
Release agent (polypropylene; Mitsui HI-WAX NP055 manufactured by Mitsui Chemicals, Inc.): 5 parts

### First Kneading Step

Of the above toner-particle-forming materials, the polyester resin (quarter), the styrene-acrylic resin (quarter), and the white colorant (whole) are mixed in a Henschel mixer, and kneading is then performed using a twin-screw extruder (i.e., a continuous kneader) illustrated in FIG. 3 under the following conditions. The number of screw rotations is 600 rpm.
Setting temperature at feed section (blocks 12A and 12B): 20° C.
Kneading setting temperature at kneading section 1 (blocks 12C to 12E): 80° C.
Kneading setting temperature at kneading section 2 (blocks 12F to 12J): 90° C.
Amount of aqueous medium (distilled water) added (based on 100 parts of raw materials supplied): 1.5 parts

In the kneading under the above conditions, the kneaded product temperature at the discharge port (the discharge port 18) of the screw extruder 11 is 100° C.

The kneaded product obtained is rapidly cooled using reduction rollers with internal brine at −5° C. and 2° C. water-cooling slab-sandwiching cooling belts, and after the cooling, the product is crushed with a hammer mill to obtain a colorant-concentrated resin composition. The rapid cooling rate is checked while the speed of the cooling belts is varied, and the average temperature decrease rate is 10° C./sec.

### Second Kneading Step

The colorant-concentrated resin composition obtained in the first kneading step and the remaining toner-particle-forming materials not used in the first kneading step are mixed in a Henschel mixer, and kneading is then performed using a twin-screw extruder (i.e., a continuous kneader) illustrated in FIG. 3 under the following conditions. The number of screw rotations is 600 rpm.
Setting temperature at feed section (blocks 12A and 12B): 20° C.
Kneading setting temperature at kneading section 1 (blocks 12C to 12E): 80° C.
Kneading setting temperature at kneading section 2 (blocks 12F to 12J): 90° C.
Amount of aqueous medium (distilled water) added (based on 100 parts of raw materials supplied): 1.5 parts

In the kneading under the above conditions, the kneaded product temperature at the discharge port (the discharge port 18) of the screw extruder 11 is 100° C.

The kneaded product obtained is rapidly cooled using reduction rollers with internal brine at −5° C. and 2° C. water-cooling slab-sandwiching cooling belts, and after the cooling, the product is crushed with a hammer mill. The rapid cooling rate is checked while the speed of the cooling belts is varied, and the average temperature decrease rate is 10° C./sec.

Thereafter, the kneaded product obtained in the second kneading step is pulverized using a pulverizer (AFG400) with a built-in coarse powder classifier to obtain pulverized particles. The pulverized particles are then classified using an inertia classifier to remove fine powder and coarse powder, thereby obtaining white toner particles (W1) having a volume-average particle size of 6.0 μm.

### External Addition of External Additive

To the white toner particles (W1) obtained, 1.5 parts of hydrophobic silica (RY50 manufactured by Nippon Aerosil Co., Ltd.) and 1.2 parts of hexamethyldisilazane-treated spherical silica having an average particle size of 130 nm are added, and mixing (external addition) is performed for 10 minutes with a Henschel mixer, after which the mixture is sieved at 45 μm using a wind-force sieving machine (Hi-BOLTER) to obtain a white toner (WT1).

### Production of White Toner (WT2)

A white toner (WT2) is obtained in the same manner as the white toner (WT1) except that the amount of the polyester resin is 10 parts, and the amount of the styrene-acrylic resin is 105 parts.

### Production of White Toner (WT3)

A white toner (WT3) is obtained in the same manner as the white toner (WT1) except that the amount of the polyester resin is 99.2 parts, and the amount of the styrene-acrylic resin is 15.8 parts.

### Production of White Toner (WT4)

A white toner (WT4) is obtained in the same manner as the white toner (WT1) except that the amount of the polyester resin is 104 parts, and the amount of the styrene-acrylic resin is 11 parts.

### Production of White Toner (WT5)

A white toner (WT6) is obtained in the same manner as the white toner (WT1) except that the amount of the polyester resin is 108 parts, and the amount of the styrene-acrylic resin is 7 parts.

### Production of White Toner (WT6)

A white toner (WT6) is obtained in the same manner as the white toner (WT1) except that the amount of the polyester resin is 60 parts, the amount of the styrene-acrylic resin is 15 parts, and the amount of the white colorant is 120 parts.

### Production of White Toner (WT7)

A white toner (WT7) is obtained in the same manner as the white toner (WT1) except that the amount of the polyester resin is 140 parts, the amount of the styrene-acrylic resin is 15 parts, and the amount of the white colorant is 40 parts.

### Production of White Toner (WT8)

A white toner (WT8) is obtained in the same manner as the white toner (WT1) except that the whole materials are used in the first kneading, and the second kneading step is not performed.

### Production of White Toner (WT9)

A white toner (WT9) is obtained in the same manner as the white toner (WT1) except that the whole materials are used in the first kneading, the number of screw rotations in the first kneading is 500 rpm, and the second kneading step is not performed.

### Production of White Toner (WT10)

A white toner (WT10) is obtained in the same manner as the white toner (WT1) except that the amount of the polyester resin is 115 parts, and the amount of the styrene-acrylic resin is 0 parts.

### Production of White Toner (WT11)

A white toner (WT11) is obtained in the same manner as the white toner (WT1) except that the amount of the polyester resin is 106 parts, and the amount of the styrene-acrylic resin is 9 parts.

### Production of White Toner (WT12)

A white toner (WT12) is obtained in the same manner as the white toner (WT1) except that the amount of the polyester resin is 85 parts, and the amount of the styrene-acrylic resin is 30 parts.

### Production of White Toner (WT13)

A white toner (WT13) is obtained in the same manner as the white toner (WT1) except that the amount of the polyester resin is 102.2 parts, and the amount of the styrene-acrylic resin is 12.8 parts.

### Production of White Toner (WT14)

A white toner (WT14) is obtained in the same manner as the white toner (WT1) except that the amount of the polyester resin is 92 parts, and the amount of the styrene-acrylic resin is 23 parts.

### Production of White Toner (WT101)

White toner particles (W101) are obtained in the same manner as the white toner particles (W1) except that 47.5 parts of the polyester resin, 10 parts of the styrene-acrylic resin, and 80 parts of the white colorant (MT1) are used as the toner-particle-forming materials, the number of screw rotations in the kneading step is 500 rpm, the kneading setting temperature at kneading section 1 is 100° C., the kneading setting temperature at kneading section 2 is 110° C., and the second kneading step is not performed. The kneaded product temperature at the discharge port (the discharge port 18) of the screw extruder 11 is 120° C.

### External Addition of External Additive

To the white toner particles (W101) obtained, hydrophobic silica (RY50 manufactured by Nippon Aerosil Co., Ltd.) and 1.2 parts of hexamethyldisilazane-treated spherical silica having an average particle size of 130 nm are added, and mixing (external addition) is performed for 10 minutes with a Henschel mixer, after which the mixture is sieved at 45 μm using a wind-force sieving machine (Hi-BOLTER) to obtain a white toner (WT101).

### Production of White Toners (WT102) to (WT116)

White toners (WT102) to (WT116) are obtained in the same manner as the white toner (WT101) except that with respect to the type and amount of white colorant, the white colorants (MT2 to MT16) of varied types and amounts shown in Table 3 are used.

### Production of White Toner (WT117)

A white toner (WT117) is obtained in the same manner as the white toner (WT101) except that the white colorant (MT1) is replaced with a white colorant (MT17).

Examples 1 to 28 and Comparative Examples 1 to 3 A toner set of a cyan toner and a white toner shown in Table 1 is used as a toner set of each example.

The cyan toner of the toner set of each example and a carrier (CA) obtained in a manner described below are placed in a V-blender at a mass ratio (toner/carrier)=5/95 and stirred for 20 minutes to obtain a cyan developer of each example.

The white toner of the toner set of each example and a carrier (CB) obtained in a manner described below are placed in a V-blender at a mass ratio (toner/carrier)=8/92 and stirred for 20 minutes to obtain a white developer of each example.

The cyan developer and the white developer obtained are combined to provide a developer set of each example.

### Preparation of Carrier (CA)

After 500 parts of spherical magnetite powder particles (volume-average particle size: 0.55 μm) is stirred with a Henschel mixer, 5 parts of a titanate coupling agent is added, and the mixture is heated to 100° C. and stirred for 30 minutes. Subsequently, 6.25 parts of phenol, 9.25 parts of 35% formalin, 500 parts of magnetite particles treated with a titanate coupling agent, 6.25 parts of 25% aqueous ammonia, and 425 parts of water are placed in a four-necked flask and stirred, and allowed to react at 85° C. for 120 minutes with stirring. Subsequently, the resultant is cooled to 25° C., and 500 parts of water is added, after which the supernatant fluid is removed, and the precipitate is washed with water. The precipitate washed with water is dried by heating under reduced pressure to obtain a carrier (CA) having an average particle size of m.

### Preparation of Carrier (CB)

Using a kneader, 100 parts of a ferrite core having a volume-average particle size of 35 μm is coated with a mixed solution obtained by dissolving 2.0 parts of a cyclohexyl methacrylate resin (weight-average molecular weight: 150,000), 0.6 parts of carbon black (VXC72), and 0.3 parts of melamine beads (EPOSTAR S) in 10 parts of toluene and performing mixing, thereby obtaining a carrier (CB).

### Evaluations

Using the developer set of each example, the following evaluations are performed.

First, the developers of the developer set of each example are placed in a production printer “Iridesse Production Press modified machine (FUJIFILM Business Innovation Corp.)” as an image forming apparatus.

Using this image forming apparatus, the following evaluations are performed.

### Color Development Evaluation A of Color Image

In a normal-temperature and normal-humidity (25° C. and 50% RH) environment, a 1-inch square (2.54 cm×2.54 cm) image including a white image and a cyan image is formed on an A4 sheet of black paper (76.7 g/m², Marubeni Forest LinX Co., Ltd.) such that the coverage of the white toner is 8 g/m² and the coverage of the cyan toner is 4 g/m² on the paper and that the white image and the cyan image are disposed in this order from the side closer to the paper.

The lightness (L* value) of the image is then measured with a spectrocolorimetric system (Rite 939 manufactured by X-Rite Inc.) at three different points on one and the same image, and their average is employed as a measured value; the color forming characteristics of the color image is evaluated according to the following evaluation criteria.

### Evaluation Criteria

A: Lightness of 70 or more
B+: Lightness of 67 or more and less than 70
B: Lightness of 65 or more and less than 67
C: Lightness of 60 or more and less than 65
D: Lightness of 55 or more and less than 60
E: Lightness of less than 55

### Rubbing Evaluation of Image

The image obtained in Color Development Evaluation A of Color Image is rubbed back and forth 10 times with cotton.

Image defects after the rubbing of the image are then evaluated. The evaluation is made according to the following evaluation criteria.
A: There is no image roughening.
B+: Minute image roughening is found by loupe observation, but at an acceptable level.
B: Image roughening is found by loupe observation, but at an acceptable level.
C: Slight image roughening is found by visual observation, but at an acceptable level.
D: Image roughening can be found by visual observation, and at an impractical level.
E: Image roughening markedly occurs, and at an impractical level.

### Color Development Evaluation B of Color Image

In a normal-temperature and normal-humidity (25° C. and 50% RH) environment, a 1-inch square (2.54 cm×2.54 cm) image including a white image and a cyan image is formed on an A4 sheet of black paper (76.7 g/m², Marubeni Forest LinX Co., Ltd.) such that the coverage of the white toner is 6 g/m² and the coverage of the cyan toner is 4 g/m² on the paper and that the white image and the cyan image are disposed in this order from the side closer to the paper.

The lightness (L* value) of the image is then measured with a spectrocolorimetric system (Rite 939 manufactured by X-Rite Inc.), and the color forming characteristics of the color image is evaluated according to the following evaluation criteria.

### Evaluation Criteria

A: Lightness of 70 or more
A−: Lightness of 68 or more and less than 70
B+: Lightness of 65 or more and less than 68
B: Lightness of 62 or more and less than 65
C: Lightness of 56 or more and less than 62
D: Lightness of 55 or less

### Bending Resistance Evaluation

The image obtained in Color Development Evaluation B of Color Image is evaluated by a crease evaluation in which the degree of image peeling upon bending is determined.

Specifically, the sheet of paper on which the image is formed is folded once and unfolded, the bent image is wiped with cotton, and the width of peeling (dropout) of the image is determined as a crease value, which is evaluated according to the following criteria.

### Evaluation Criteria

A: Crease value of 20 μm or less
A−: Crease value of more than 20 μm and 35 μm or less
B+: Crease value of more than 35 μm and 50 μm or less
B: Crease value of more than 50 μm and 80 μm or less
C: Crease value of more than 80 μm and 160 μm or less
D: Crease value of more than 160 μm

Tables show the following properties of the white toners and the color toners (cyan toners in EXAMPLES here).
Content of vinyl resin relative to color toner particles: mass % (denoted as “StAc percentage CS” in Tables)
Content of polyester resin relative to color toner particles: mass % (denoted as “PES percentage CP” in Tables)
Mass ratio C of polyester resin to vinyl resin in color toner particles (denoted as “PES/StAc ratio C”)
Content of vinyl resin relative to white toner particles: mass % (denoted as “StAc percentage WS” in Tables)
Content of polyester resin relative to white toner particles: mass % (denoted as “PES percentage WP” in Tables)
Mass ratio W of polyester resin to vinyl resin in white toner particles (denoted as “PES/StAc ratio W”)
Content of white colorant relative to white toner particles: mass % (denoted as “Colorant amount” in Tables)
Variance P parameter determined by measuring white colorant by block method in cross section of white toner particles (denoted as “Colorant variance P” in Tables)

Area fraction of white colorant as determined by observing cross section of white toner particles (denoted as “Colorant area fraction” in Tables)
Number-average particle size of white colorant as determined by observing cross section of white toner particles (denoted as “Colorant particle size” in Tables)
Proportion of white colorant with particle size of 100 nm or less relative to entire white colorant as determined by observing cross section of white toner particles (denoted as “Proportion of colorant with particle size of 100 nm or less” in Tables)

TABLE 1

| | Color toner | | | | White toner | | | | | | | Evaluation | |
|---|---|---|---|---|---|---|---|---|---|---|---|---|---|
| | StAc | PES | PES/ | | StAc | PES | PES/ | Color- | Color- | | | | Color |
| | percent- | percent- | StAc | | percent- | percent- | StAc | ant | ant | | | | forming |
| | age CS | age CP | ratio | Toner | age WS | age WP | ratio | amount | variance | Toner | | | character- |
| | (mass %) | (mass %) | C | name | (mass %) | (mass %) | W | (wt %) | P | name | W − C | Rubbing | istics |
| Example 1 | 18.8 | 75.3 | 4.0 | CT1 | 7.5 | 50.0 | 6.7 | 40 | 0.940 | WT1 | 2.7 | A | A |
| Example 2 | 56.5 | 37.6 | 0.7 | CT2 | 52.5 | 5.0 | 0.1 | 40 | 0.912 | WT2 | −0.6 | B | B |
| Example 3 | 56.5 | 37.6 | 0.7 | CT2 | 7.9 | 49.6 | 6.3 | 40 | 0.936 | WT3 | 5.6 | C | B+ |
| Example 4 | 8.6 | 85.6 | 10.0 | CT3 | 5.5 | 52.0 | 9.5 | 40 | 0.950 | WT4 | −0.5 | A | C |
| Example 5 | 8.6 | 85.6 | 10.0 | CT3 | 3.5 | 54.0 | 15.4 | 40 | 0.962 | WT5 | 5.4 | B | B |
| Example 6 | 18.8 | 75.3 | 4.0 | CT1 | 7.5 | 30.0 | 4.0 | 60 | 0.982 | WT6 | 0.0 | B+ | A |
| Example 7 | 18.8 | 75.3 | 4.0 | CT1 | 7.5 | 70.0 | 9.3 | 20 | 0.910 | WT7 | 5.3 | A | B+ |
| Example 8 | 18.8 | 75.3 | 4.0 | CT1 | 7.5 | 50.0 | 6.7 | 40 | 0.862 | WT8 | 2.7 | A | B+ |
| Example 9 | 31.4 | 62.7 | 2.0 | CT4 | 7.5 | 50.0 | 6.7 | 40 | 0.940 | WT1 | 4.7 | B+ | A |
| Example 10 | 13.4 | 80.7 | 6.0 | CT5 | 7.5 | 50.0 | 6.7 | 40 | 0.940 | WT1 | 0.7 | A | B+ |
| Example 11 | 18.8 | 75.3 | 4.0 | CT1 | 7.5 | 50.0 | 6.7 | 40 | 0.812 | WT9 | 2.7 | A | B |
| Example 12 | 18.8 | 75.3 | 4.0 | CT1 | 0.0 | 57.5 | Not cal- | 40 | 0.980 | WT10 | Not cal- | A | B |
| | | | | | | | culable | | | | culable | | |
| Example 13 | 13.7 | 80.4 | 5.9 | CT6 | 4.5 | 53.0 | 11.8 | 40 | 0.959 | WT11 | 5.9 | A | B+ |
| Example 14 | 18.8 | 75.3 | 4.0 | CT1 | 15.0 | 42.5 | 2.8 | 40 | 0.928 | WT12 | −1.2 | A | B |
| Example 15 | 18.8 | 75.3 | 4.0 | CT1 | 6.4 | 51.1 | 8.0 | 40 | 0.945 | WT13 | 4.0 | A | A |
| Example 16 | 18.8 | 75.3 | 4.0 | CT1 | 11.5 | 46.0 | 4.0 | 40 | 0.930 | WT14 | 0.0 | A | A |
| Example 17 | 12.3 | 81.8 | 6.7 | CT7 | 7.5 | 50.0 | 6.7 | 40 | 0.940 | WT1 | 0.0 | A | B |
| Example 18 | 47.1 | 47.1 | 1.0 | CT8 | 7.5 | 50.0 | 6.7 | 40 | 0.940 | WT1 | 5.7 | B | A |
| Example 19 | 18.4 | 75.9 | 4.1 | CT9 | 7.5 | 50.0 | 6.7 | 40 | 0.940 | WT1 | 2.5 | A | A |
| Comparative | 85.6 | 8.6 | 0.1 | CT10 | 7.5 | 50.0 | 6.7 | 40 | 0.940 | WT1 | 6.6 | E | A |
| Example 1 | | | | | | | | | | | | | |
| Comparative | 5.9 | 88.2 | 15.0 | CT11 | 7.5 | 50.0 | 6.7 | 40 | 0.940 | WT1 | −8.3 | A | E |
| Example 2 | | | | | | | | | | | | | |

The above results show that in Examples, compared with Comparative Examples, the color forming characteristics of a color image are high, and image roughening is less likely to occur in the rubbing evaluation of an image, indicating that an image including a color image on a white image is provided with high color forming characteristics and color image peeling is suppressed.

TABLE 2-1

| | Color toner | | | | | |
|---|---|---|---|---|---|---|
| | | | Amorphous | | | |
| | StAc | Crystalline | PES A1 or | PES | | |
| | percentage | PES B1 | SPE101 | percentage | PES/StAc | |
| | CS (mass %) | (mass %) | (mass %) | CP (mass %) | ratio C | Type |
| Example 1 | 12 | 2 | 46 | 48 | 4.0 | CT101 |
| Example 2 | 36 | 2 | 22 | 24 | 0.7 | CT102 |
| Example 3 | 20 | 2 | 38 | 40 | 2.0 | CT103 |
| Example 4 | 9 | 2 | 50 | 52 | 5.8 | CT104 |
| Example 5 | 5.5 | 2 | 53 | 55 | 10.0 | CT105 |
| Example 6 | 12 | 2 | 9.2 | 48 | 4.0 | CT101 |
| Example 7 | 12 | 2 | 9.2 | 48 | 4.0 | CT101 |
| Example 8 | 12 | 2 | 9.2 | 48 | 4.0 | CT101 |
| Example 9 | 12 | 2 | 9.2 | 48 | 4.0 | CT101 |
| Example 10 | 12 | 2 | 9.2 | 48 | 4.0 | CT101 |
| Example 11 | 12 | 2 | 9.2 | 48 | 4.0 | CT101 |
| Example 12 | 12 | 2 | 9.2 | 48 | 4.0 | CT101 |
| Example 13 | 12 | 2 | 9.2 | 48 | 4.0 | CT101 |
| Example 14 | 12 | 2 | 9.2 | 48 | 4.0 | CT101 |
| Example 15 | 12 | 2 | 9.2 | 48 | 4.0 | CT101 |
| Example 16 | 12 | 2 | 9.2 | 48 | 4.0 | CT101 |
| Example 17 | 12 | 2 | 9.2 | 48 | 4.0 | CT101 |
| Example 18 | 12 | 2 | 9.2 | 48 | 4.0 | CT101 |
| Example 19 | 12 | 2 | 9.2 | 48 | 4.0 | CT101 |
| Example 20 | 12 | 2 | 9.2 | 48 | 4.0 | CT101 |
| Example 21 | 12 | 2 | 9.2 | 48 | 4.0 | CT101 |
| Example 22 | 12 | 2 | 9.2 | 48 | 4.0 | CT101 |
| Example 23 | 12 | 2 | 9.2 | 48 | 4.0 | CT101 |
| Example 24 | 12.0 | 2.0 | 46.0 | 48.0 | 4.0 | CT108 |
| Comparative | 0 | 2 | 9.2 | 60 | — | CT109 |
| Example 1 | | | | | | |
| Comparative | 38 | 2 | 20 | 22 | 0.6 | CT106 |
| Example 2 | | | | | | |
| Comparative | 4 | 2 | 54 | 56 | 14.0 | CT107 |
| Example 3 | | | | | | |
| Example 25 | 12 | 2 | 9.2 | 48 | 4.0 | CT101 |
| Example 26 | 12 | 2 | 9.2 | 48 | 4.0 | CT101 |
| Example 27 | 12 | 2 | 9.2 | 48 | 4.0 | CT101 |
| Example 28 | 12 | 2 | 9.2 | 48 | 4.0 | CT101 |

TABLE 2-2

| | White toner | | | | | | | | | | |
|---|---|---|---|---|---|---|---|---|---|---|---|
| | | | | | | | Proportion | | | | |
| | | | | | | | of colorant | | | | |
| | | | | | | | with particle | | | | |
| | StAc | PES | | | Colorant | Colorant | size of | | | Evaluation | |
| | percentage | percentage | | Colorant | area | particle | 100 nm | | | Color | |
| | WS | WP | PES/StAc | amount | fraction | size | or less | | | forming | Bending |
| | (mass %) | (mass %) | ratio W | (mass %) | (%) | (μm) | (number %) | Type | W − C | characteristics | resistance |
| Example 1 | 10 | 47.5 | 4.8 | 80 | 35 | 0.280 | 15 | WT101 | 0.8 | A | A |
| Example 2 | 25 | 32.5 | 1.3 | 80 | 35 | 0.280 | 15 | WT101 | 0.6 | A | B |
| Example 3 | 15 | 42.5 | 2.8 | 80 | 35 | 0.280 | 15 | WT101 | 0.8 | A | A− |
| Example 4 | 7 | 50.5 | 7.2 | 80 | 35 | 0.280 | 15 | WT101 | 1.4 | A− | A |
| Example 5 | 4 | 53.5 | 13.4 | 80 | 35 | 0.280 | 15 | WT101 | 3.4 | B | A |
| Example 6 | 10 | 47.5 | 4.8 | 23 | 10 | 0.280 | 15 | WT102 | 0.8 | A | B |
| Example 7 | 10 | 47.5 | 4.8 | 43.5 | 19 | 0.280 | 15 | WT103 | 0.8 | B | A |
| Example 8 | 10 | 47.5 | 4.8 | 126 | 50 | 0.280 | 15 | WT104 | 0.8 | B | A |
| Example 9 | 10 | 47.5 | 4.8 | 126 | 50 | 0.280 | 15 | WT105 | 0.8 | B | B |
| Example 10 | 10 | 47.5 | 4.8 | 80 | 35 | 0.230 | 11 | WT106 | 0.8 | A | B |
| Example 11 | 10 | 47.5 | 4.8 | 80 | 35 | 0.230 | 11 | WT107 | 0.8 | A | B |
| Example 12 | 10 | 47.5 | 4.8 | 80 | 35 | 0.301 | 7 | WT108 | 0.8 | B | A |
| Example 13 | 10 | 47.5 | 4.8 | 80 | 35 | 0.398 | 2 | WT109 | 0.8 | B | A |
| Example 14 | 15 | 47.5 | 3.2 | 80 | 35 | 0.280 | 15 | WT101 | −0.8 | B+ | A |
| Example 15 | 14 | 47.5 | 3.4 | 80 | 35 | 0.280 | 15 | WT101 | −0.6 | A− | A |
| Example 16 | 12 | 47.5 | 4.0 | 80 | 35 | 0.280 | 15 | WT101 | 0.0 | A | A |
| Example 17 | 6 | 47.5 | 7.9 | 80 | 35 | 0.280 | 15 | WT101 | 3.9 | A | A |
| Example 18 | 5 | 47.5 | 9.6 | 80 | 35 | 0.280 | 15 | WT101 | 5.6 | A | A− |
| Example 19 | 5 | 47.5 | 10.6 | 80 | 35 | 0.280 | 15 | WT101 | 6.6 | A | B+ |
| Example 20 | 10 | 47.5 | 4.8 | 80 | 35 | 0.248 | 20 | WT110 | 0.8 | A | A |
| Example 21 | 10 | 47.5 | 4.8 | 80 | 35 | 0.233 | 29 | WT111 | 0.8 | A | A− |
| Example 22 | 10 | 47.5 | 4.8 | 80 | 35 | 0.240 | 33 | WT112 | 0.8 | A | B+ |
| Example 23 | 10 | 47.5 | 4.8 | 80 | 35 | 0.435 | 0 | WT117 | 0.8 | B+ | A |
| Example 24 | 10.0 | 47.5 | 4.75 | 80 | 35 | 0.280 | 15.00 | WT101 | 0.8 | A | A |
| Comparative | 10 | 47.5 | 4.8 | 80 | 35 | 0.280 | 15 | WT101 | — | A | D |
| Example 1 | | | | | | | | | | | |
| Comparative | 10 | 47.5 | 4.8 | 80 | 35 | 0.280 | 15 | WT101 | 4.2 | A | D |
| Example 2 | | | | | | | | | | | |
| Comparative | 10 | 47.5 | 4.8 | 80 | 35 | 0.280 | 15 | WT101 | −9.3 | D | A |
| Example 3 | | | | | | | | | | | |
| Example 25 | 10 | 47.5 | 4.8 | 20 | 8 | 0.280 | 15 | WT113 | 0.8 | C | A |
| Example 26 | 10 | 47.5 | 4.8 | 160 | 60 | 0.280 | 15 | WT114 | 0.8 | A | C |
| Example 27 | 10 | 47.5 | 4.8 | 80 | 35 | 0.216 | 11 | WT115 | 0.8 | A | C |
| Example 28 | 10 | 47.5 | 4.8 | 80 | 35 | 0.535 | 0 | WT117 | 0.8 | C | A |

TABLE 3

| | Addition | Addition | | | |
|---|---|---|---|---|---|
| | amount A | amount B | Addition | Addition | |
| | Titanium oxide | Titanium oxide | amount C | amount E | Number-average |
| | particles | particles | Titanium oxide | Titanium oxide | particle size |
| White | (T1) | (T2) | particles (T3) | particles (T4) | Dcc |
| colorant | parts | parts | parts | parts | (nm) |
| MT1 | 30 | 70 | 0 | 0 | 280 |
| MT2 | 30 | 70 | 0 | 0 | 280 |
| MT3 | 30 | 70 | 0 | 0 | 280 |
| MT4 | 30 | 70 | 0 | 0 | 280 |
| MT5 | 30 | 70 | 0 | 0 | 280 |
| MT6 | 16 | 84 | 0 | 0 | 244 |
| MT7 | 16 | 84 | 0 | 0 | 244 |
| MT8 | 45 | 55 | 0 | 0 | 319 |
| MT9 | 85 | 15 | 0 | 0 | 422 |
| MT10 | 30 | 40 | 30 | 0 | 262 |
| MT11 | 30 | 15 | 55 | 0 | 247 |
| MT12 | 35 | 0 | 65 | 0 | 254 |
| MT13 | 30 | 70 | 0 | 0 | 280 |
| MT14 | 30 | 70 | 0 | 0 | 280 |
| MT15 | 10 | 90 | 0 | 0 | 228 |
| MT16 | 100 | 0 | 0 | 0 | 461 |
| MT17 | 0 | 0 | 0 | 100 | 525 |

The above results show that in Examples, compared with Comparative Examples, the color forming characteristics of a color image are high, and the crease value is small in the bending resistance evaluation of an image, indicating that an image including a color image on a white image is provided with high color forming characteristics and image peeling upon bending is suppressed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A toner set for electrostatic image development, comprising:
a white toner including white toner particles containing a polyester resin and a white colorant; and
a non-white color toner including color toner particles containing a vinyl resin, a polyester resin, and a color colorant, wherein a mass ratio C of the polyester resin to the vinyl resin in the color toner particles is 0.7 or more and 10 or less.
   (((2)))

The toner set for electrostatic image development according to (((1))), wherein the mass ratio C of the polyester resin to the vinyl resin in the color toner particles is 2 or more and 6 or less.

(((3)))

The toner set for electrostatic image development according to (((1))), wherein in a cross section of the white toner particles, a variance P parameter determined by measuring the white colorant by a block method is 0.85 or more and 1.00 or less.

(((4)))

The toner set for electrostatic image development according to (((3))), wherein in the cross section of the white toner particles, the variance P parameter determined by measuring the white colorant by the block method is 0.90 or more and 1.00 or less.

(((5)))

The toner set for electrostatic image development according to any one of (((1))) to (((4))), wherein the white toner particles contain a vinyl resin.

(((6)))

The toner set for electrostatic image development according to (((5))), wherein a relationship between a mass ratio W of the polyester resin to the vinyl resin in the white toner particles and the mass ratio C of the polyester resin to the vinyl resin in the color toner particles satisfies −0.6≤W−C≤5.6.

(((7)))

The toner set for electrostatic image development according to (((6))), wherein the relationship between the mass ratio W of the polyester resin to the vinyl resin in the white toner particles and the mass ratio C of the polyester resin to the vinyl resin in the color toner particles satisfies 0≤W−C≤4.

(((8)))

The toner set for electrostatic image development according to any one of (((1))) to (((7))), wherein a content of the white colorant relative to the white toner particles is 20 mass % or more and 60 mass % or less.

(((9)))

The toner set for electrostatic image development according to (((1))), wherein when a cross section of the white toner particles is observed, the white colorant has an area fraction of 10% or more and 50% or less, and the white colorant has a number-average particle size of 0.23 μm or more and 0.45 μm or less.

(((10)))

The toner set for electrostatic image development according to (((9))), wherein when the cross section of the white toner particles is observed, the white colorant has an area fraction of 20% or more and 50% or less, and the white colorant has a number-average particle size of 0.23 μm or more and 0.30 μm or less.

(((11)))

The toner set for electrostatic image development according to (((9))), wherein when the cross section of the white toner particles is observed, a proportion of a white colorant with a particle size of 100 nm or less relative to the entire white colorant is 30 number % or less.

(((12)))

The toner set for electrostatic image development according to (((11))), wherein when the cross section of the white toner particles is observed, the proportion of the white colorant with a particle size of 100 nm or less relative to the entire white colorant is 20 number % or less.

(((13)))

An electrostatic image developer set comprising:
a white electrostatic image developer containing the white toner included in the toner set for electrostatic image development according to any one of (((1))) to (((12))); and
a color electrostatic image developer containing the color toner included in the toner set for electrostatic image development according to any one of (((1))) to (((12))).
   (((14)))

A toner cartridge set comprising:
a white toner cartridge that contains the white toner included in the toner set for electrostatic image development according to any one of (((1))) to (((12))) and that is attachable to and detachable from an image forming apparatus; and
a color toner cartridge that contains the color toner included in the toner set for electrostatic image development according to any one of (((1))) to (((12))) and that is attachable to and detachable from the image forming apparatus.
   (((15)))

A process cartridge attachable to and detachable from an image forming apparatus, the process cartridge comprising:
a first developing unit containing the white electrostatic image developer included in the electrostatic image developer set according to (((13))); and
a second developing unit containing the color electrostatic image developer included in the electrostatic image developer set according to (((13))).
   (((16)))

An image forming apparatus comprising:
a first image forming unit that includes a first developing unit containing the white electrostatic image developer included in the electrostatic image developer set according to (((13))) and that forms a white image with the white toner;
a second image forming unit that includes a second developing unit containing the color electrostatic image developer included in the electrostatic image developer set according to (((13))) and that forms a color image with the color toner;
a transfer unit that transfers the white image and the color image to a surface of a recording medium; and
a fixing unit that fixes the white image and the color image transferred to the surface of the recording medium.
   (((17)))

An image forming method comprising:
forming a white image with the white toner included in the toner set for electrostatic image development according to any one of (((1))) to (((12)));
forming a color image with the color toner included in the toner set for electrostatic image development according to any one of (((1))) to (((12)));
transferring the white image and the color image to a surface of a recording medium; and
fixing the white image and the color image transferred to the surface of the recording medium.

What is claimed is:

1. A toner set for electrostatic image development, comprising:
a white toner including white toner particles containing a polyester resin and a white colorant; and
a non-white color toner including color toner particles containing a vinyl resin, a polyester resin, and a color colorant,
wherein a mass ratio C of the polyester resin to the vinyl resin in the color toner particles is 0.7 or more and 10 or less.

2. The toner set for electrostatic image development according to claim 1, wherein the mass ratio C of the polyester resin to the vinyl resin in the color toner particles is 2 or more and 6 or less.

3. The toner set for electrostatic image development according to claim 1, wherein in a cross section of the white toner particles, a variance P parameter determined by measuring the white colorant by a block method is 0.85 or more and 1.00 or less.

4. The toner set for electrostatic image development according to claim 3, wherein in the cross section of the white toner particles, the variance P parameter determined by measuring the white colorant by the block method is 0.90 or more and 1.00 or less.

5. The toner set for electrostatic image development according to claim 1, wherein the white toner particles contain a vinyl resin.

6. The toner set for electrostatic image development according to claim 5, wherein a relationship between a mass ratio W of the polyester resin to the vinyl resin in the white toner particles and the mass ratio C of the polyester resin to the vinyl resin in the color toner particles satisfies −0.6≤W−C≤5.6.

7. The toner set for electrostatic image development according to claim 6, wherein the relationship between the mass ratio W of the polyester resin to the vinyl resin in the white toner particles and the mass ratio C of the polyester resin to the vinyl resin in the color toner particles satisfies 0≤W−C≤4.

8. The toner set for electrostatic image development according to claim 1, wherein a content of the white colorant relative to the white toner particles is 20 mass % or more and 60 mass % or less.

9. The toner set for electrostatic image development according to claim 1, wherein when a cross section of the white toner particles is observed, the white colorant has an area fraction of 10% or more and 50% or less, and the white colorant has a number-average particle size of 0.23 μm or more and 0.45 μm or less.

10. The toner set for electrostatic image development according to claim 9, wherein when the cross section of the white toner particles is observed, the white colorant has an area fraction of 20% or more and 50% or less, and the white colorant has a number-average particle size of 0.23 μm or more and 0.30 μm or less.

11. The toner set for electrostatic image development according to claim 9, wherein when the cross section of the white toner particles is observed, a proportion of a white colorant with a particle size of 100 nm or less relative to the entire white colorant is 30 number % or less.

12. The toner set for electrostatic image development according to claim 11, wherein when the cross section of the white toner particles is observed, the proportion of the white colorant with a particle size of 100 nm or less relative to the entire white colorant is 20 number % or less.

13. An electrostatic image developer set comprising:
a white electrostatic image developer containing the white toner included in the toner set for electrostatic image development according to claim 1; and
a color electrostatic image developer containing the color toner included in the toner set for electrostatic image development according to claim 1.

14. An electrostatic image developer set comprising:
a white electrostatic image developer containing the white toner included in the toner set for electrostatic image development according to claim 2; and
a color electrostatic image developer containing the color toner included in the toner set for electrostatic image development according to claim 2.

15. An electrostatic image developer set comprising:
a white electrostatic image developer containing the white toner included in the toner set for electrostatic image development according to claim 3; and
a color electrostatic image developer containing the color toner included in the toner set for electrostatic image development according to claim 3.

16. An electrostatic image developer set comprising:
a white electrostatic image developer containing the white toner included in the toner set for electrostatic image development according to claim 4; and
a color electrostatic image developer containing the color toner included in the toner set for electrostatic image development according to claim 4.

17. A toner cartridge set comprising:
a white toner cartridge that contains the white toner included in the toner set for electrostatic image development according to claim 1 and that is attachable to and detachable from an image forming apparatus; and
a color toner cartridge that contains the color toner included in the toner set for electrostatic image development according to claim 1 and that is attachable to and detachable from the image forming apparatus.

18. A process cartridge attachable to and detachable from an image forming apparatus, the process cartridge comprising:
a first developing unit containing the white electrostatic image developer included in the electrostatic image developer set according to claim 13; and
a second developing unit containing the color electrostatic image developer included in the electrostatic image developer set according to claim 13.

19. An image forming apparatus comprising:
a first image forming unit that includes a first developing unit containing the white electrostatic image developer included in the electrostatic image developer set according to claim 13 and that forms a white image with the white toner;
a second image forming unit that includes a second developing unit containing the color electrostatic image developer included in the electrostatic image developer set according to claim 13 and that forms a color image with the color toner;
a transfer unit that transfers the white image and the color image to a surface of a recording medium; and
a fixing unit that fixes the white image and the color image transferred to the surface of the recording medium.

20. An image forming method comprising:
forming a white image with the white toner included in the toner set for electrostatic image development according to claim 1;
forming a color image with the color toner included in the toner set for electrostatic image development according to claim 1;
transferring the white image and the color image to a surface of a recording medium; and
fixing the white image and the color image transferred to the surface of the recording medium.
